(19) United States
(12) Patent Application Publication
(10) Pub. No.: US 2026/0246857 A1
(43) Pub. Date: Aug. 20, 2026

(54) LAYER 2 (L2) PROCEDURES FOR APPLICATION DATA UNIT (ADU) BASED SCHEDULING

(71) Applicant: QUALCOMM Incorporated, San Diego, CA (US)

(72) Inventors: Linhai HE, San Diego, CA (US); Gavin Bernard HORN, La Jolla, CA (US); Miguel GRIOT, La Jolla, CA (US); Ruiming ZHENG, Beijing (CN); Yuchul KIM, San Diego, CA (US); Huilin XU, Temecula, CA (US)

(21) Appl. No.: 18/852,351

(22) PCT Filed: Feb. 22, 2023
(86) PCT No.: PCT/CN2023/077615

§ 371 Date: Sep. 27, 2024

(30) Foreign Application Priority Data
May 26, 2022 (WO) PCT/CN2022/095113

(51) Int. Cl. H04L 69/322; H04L 43/0876

(52) U.S. Cl. CPC H04L 69/322; H04L 43/0876

(57) ABSTRACT

Certain aspects of the present disclosure provide a method for wireless communications by a transmitter node. The transmitter node receives one or more data packets of a plurality of data packets within a same protocol data unit (PDU) set, the plurality of data packets belong to one or more PDU sets. The transmitter node applies one or more same processing procedures to the one or more data packets within the same PDU set.

### CROSS-REFERENCE TO RELATED APPLICATION

This application claims benefit of and priority to PCT Patent Application No. PCT/ CN 2022/095113, filed May 26, 2022, which is hereby incorporated by reference in its entirety.

### BACKGROUND

### Field of the Disclosure

Aspects of the present disclosure relate to wireless communications, and more particularly, to layer 2 (L2) procedures for protocol data unit (PDU) set based scheduling.

### Description of Related Art

Wireless communications systems are widely deployed to provide various telecommunication services such as telephony, video, data, messaging, broadcasts, or other similar types of services. These wireless communications systems may employ multiple-access technologies capable of supporting communications with multiple users by sharing available wireless communications system resources with those users.

Although wireless communications systems have made great technological advancements over many years, challenges still exist. For example, complex and dynamic environments can still attenuate or block signals between wireless transmitters and wireless receivers. Accordingly, there is a continuous desire to improve the technical performance of wireless communications systems, including, for example: improving speed and data carrying capacity of communications, improving efficiency of the use of shared communications mediums, reducing power used by transmitters and receivers while performing communications, improving reliability of wireless communications, avoiding redundant transmissions and/or receptions and related processing, improving the coverage area of wireless communications, increasing the number and types of devices that can access wireless communications systems, increasing the ability for different types of devices to intercommunicate, increasing the number and type of wireless communications mediums available for use, and the like. Consequently, there exists a need for further improvements in wireless communications systems to overcome the aforementioned technical challenges and others.

### SUMMARY

One aspect provides a method for wireless communications by a receiver node, comprising: receiving a plurality of data packets belonging to one or more protocol data unit (PDU) sets and an indication indicating a policy for a delivery procedure of one or more data packets in each PDU set to a higher layer; and delivering the one or more data packets within a same PDU set to the higher layer, in accordance with the policy.

Another aspect provides a method for wireless communications by a transmitter node, comprising: receiving one or more data packets of a plurality of data packets within a same PDU set, the plurality of data packets belong to one or more PDU sets; and applying one or more same processing procedures to the one or more data packets within the same PDU set.

Other aspects provide: an apparatus operable, configured, or otherwise adapted to perform the aforementioned methods as well as those described elsewhere herein; a non-transitory, computer-readable media comprising instructions that, when executed by a processor of an apparatus, cause the apparatus to perform the aforementioned methods as well as those described elsewhere herein; a computer program product embodied on a computer-readable storage medium comprising code for performing the aforementioned methods as well as those described elsewhere herein; and an apparatus comprising means for performing the aforementioned methods as well as those described elsewhere herein. By way of example, an apparatus may comprise a processing system, a device with a processing system, or processing systems cooperating over one or more networks.

The following description and the appended figures set forth certain features for purposes of illustration.

### BRIEF DESCRIPTION OF DRAWINGS

The appended figures depict certain features of the various aspects described herein and are not to be considered limiting of the scope of this disclosure.

FIG. 1 depicts an example wireless communications network.

FIG. 2 depicts an example disaggregated base station (BS) architecture.

FIG. 3 depicts aspects of an example BS and an example user equipment (UE).

FIGS. 4A, 4B, 4C, and 4D depict various example aspects of data structures for a wireless communications network.

FIG. 5 depicts example layer 2 (L2) architecture.

FIG. 6 depicts example transmitting node packet data convergence protocol (PDCP) entity and receiving node PDCP entity.

FIG. 7 depicts example PDCP protocol data unit (PDU).

FIG. 8 depicts a method for wireless communications by a receiver node.

FIG. 9 depicts a method for wireless communications by a transmitter node.

FIG. 10 depicts example PDU set based PDCP out-of-order delivery of data packets.

FIG. 11 depicts example PDU set based PDCP in-order delivery of data packets.

FIG. 12 depicts example flow of PDU set information across L2 protocol stack indicating adding of PDU set information to a PDCP header.

FIG. 13 depicts example PDCP header with PDU set information.

FIG. 14 depicts example flow of PDU set information across L2 protocol stack indicating adding of PDU set information to a medium access control (MAC) sub-PDU header.

FIG. 15 depicts example MAC sub-PDU header with PDU set information.

FIG. 16 depicts example multiple sub-PDUs assembled into a single PDCP PDU where each sub-PDU is associated with one or more first attributes.

FIG. 17 depicts example multiple sub-PDUs assembled into a single PDCP PDU where each sub-PDU is associated with one or more second attributes.

FIG. 18 depicts example grouping of all sub-PDUs to form a single PDCP PDU where each sub-PDU is associated with one or more third attributes.

FIG. 19 depicts aspects of an example communications device.

FIG. 20 depicts aspects of an example communications device.

### DETAILED DESCRIPTION

Aspects of the present disclosure provide apparatuses, methods, processing systems, and computer-readable mediums for layer 2 (L2) procedures for protocol data unit (PDU) set based scheduling. The L2 procedures may include a packet data convergence protocol (PDCP) layer procedure, a radio link control (RLC) layer procedure, and/or a medium access control (MAC) layer procedure.

An extended reality (XR) application generates and consumes in data units, which are larger than internet protocol (IP) packets (e.g., data packets). The data units are called PDU sets. A PDU set is also known as an application data unit (ADU). The PDU sets are segmented into the data packets when the PDU sets are transmitted over a core network (CN). Although the data packets of each PDU set typically arrive at a receiver around a same time, however, in some cases, the data packets of each PDU set may not arrive at the same time. Also, all data packets in an PDU set have same quality of service (QOS) requirements.

Current L2 procedures are configured and performed on basis of individual data packets (and their QoS requirements), and not on a PDU set. That is, different L2 procedures are applied on different data packets, and the different data packets maybe processed separately (due to their different arrival time). However, in the PDU set, all data packets have same QoS requirements and have to be processed together. This is because if any data packet of the PDU set does not meet its QoS deadline or is lost, then remaining data packets of the PDU set become useless and the PDU set has to be discarded.

The present application describes enhancements in the L2 procedures to support PDU set-based scheduling, to achieve successful processing (e.g., jointly or separately) of the data packets of the PDU set. For example, the enhancements to the L2 procedures may enable determining the data packets that belong to the same PDU set and subsequent application of same processing procedures on the data packets of the same PDU set. The L2 procedures proposed herein are able to meet same quality of service (QoS) requirements of the data packets of the PDU set during the processing of the data packets.

### Introduction to Wireless Communications Networks

The techniques and methods described herein may be used for various wireless communications networks. While aspects may be described herein using terminology commonly associated with 3G, 4G, and/or 5G wireless technologies, aspects of the present disclosure may likewise be applicable to other communications systems and standards not explicitly mentioned herein.

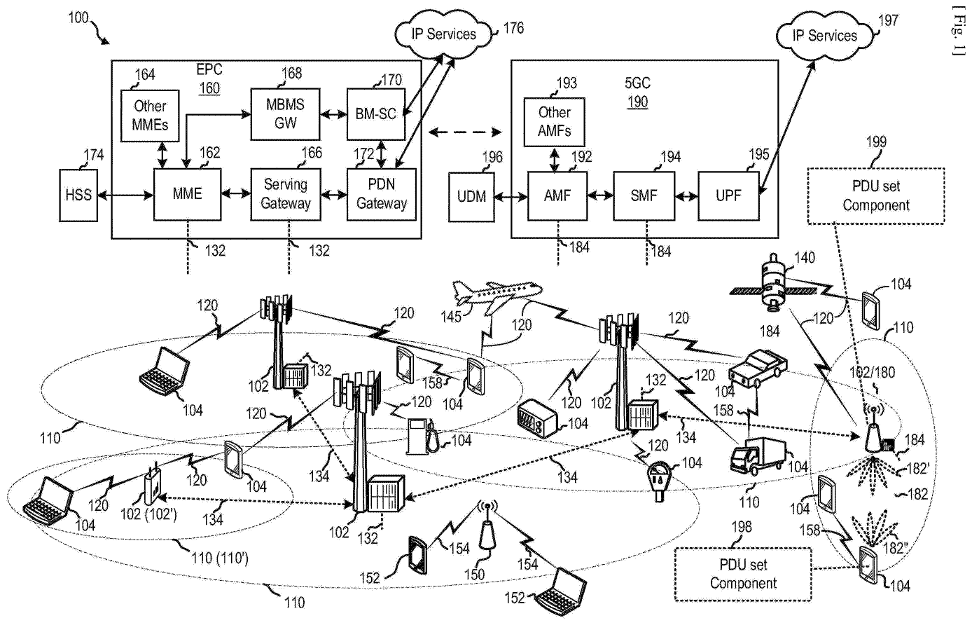

FIG. 1 depicts an example of a wireless communications network 100, in which aspects described herein may be implemented.

Generally, wireless communications network 100 includes various network entities (alternatively, network elements or network nodes). A network entity is generally a communications device and/or a communications function performed by a communications device (e.g., a user equipment (UE), a base station (BS), a component of a BS, a server, etc. ). For example, various functions of a network as well as various devices associated with and interacting with a network may be considered network entities. Further, wireless communications network 100 includes terrestrial aspects, such as ground-based network entities (e.g., BSs 102), and non-terrestrial aspects, such as satellite 140 and aircraft 145, which may include network entities on-board (e.g., one or more BSs) capable of communicating with other network elements (e.g., terrestrial BSs) and UEs.

In the depicted example, wireless communications network 100 includes BSs 102, UEs 104, and one or more core networks, such as an Evolved Packet Core (EPC) 160 and 5G Core (5GC) network 190, which interoperate to provide communications services over various communications links, including wired and wireless links.

FIG. 1 depicts various example UEs 104, which may more generally include: a cellular phone, smart phone, session initiation protocol (SIP) phone, laptop, personal digital assistant (PDA), satellite radio, global positioning system, multimedia device, video device, digital audio player, camera, game console, tablet, smart device, wearable device, vehicle, electric meter, gas pump, large or small kitchen appliance, healthcare device, implant, sensor/actuator, display, internet of things (IOT) devices, always on (AON) devices, edge processing devices, or other similar devices. UEs 104 may also be referred to more generally as a mobile device, a wireless device, a wireless communications device, a station, a mobile station, a subscriber station, a mobile subscriber station, a mobile unit, a subscriber unit, a wireless unit, a remote unit, a remote device, an access terminal, a mobile terminal, a wireless terminal, a remote terminal, a handset, and others.

BSs 102 wirelessly communicate with (e.g., transmit signals to or receive signals from) UEs 104 via communications links 120. The communications links 120 between BSs 102 and UEs 104 may include uplink (UL) (also referred to as reverse link) transmissions from a UE 104 to a BS 102 and/or downlink (DL) (also referred to as forward link) transmissions from a BS 102 to a UE 104. The communications links 120 may use multiple-input and multiple-output (MIMO) antenna technology, including spatial multiplexing, beamforming, and/or transmit diversity in various aspects.

BSs 102 may generally include: a NodeB, enhanced NodeB (eNB), next generation enhanced NodeB (ng-eNB), next generation NodeB (gNB or gNodeB), access point, base transceiver station, radio BS, radio transceiver, transceiver function, transmission reception point, and/or others. Each of BSs 102 may provide communications coverage for a respective geographic coverage area 110, which may sometimes be referred to as a cell, and which may overlap in some cases (e.g., small cell 102′ may have a coverage area 110′ that overlaps the coverage area 110 of a macro cell). A BS may, for example, provide communications coverage for a macro cell (covering relatively large geographic area), a pico cell (covering relatively smaller geographic area, such as a sports stadium), a femto cell (relatively smaller geographic area (e.g., a home)), and/or other types of cells.

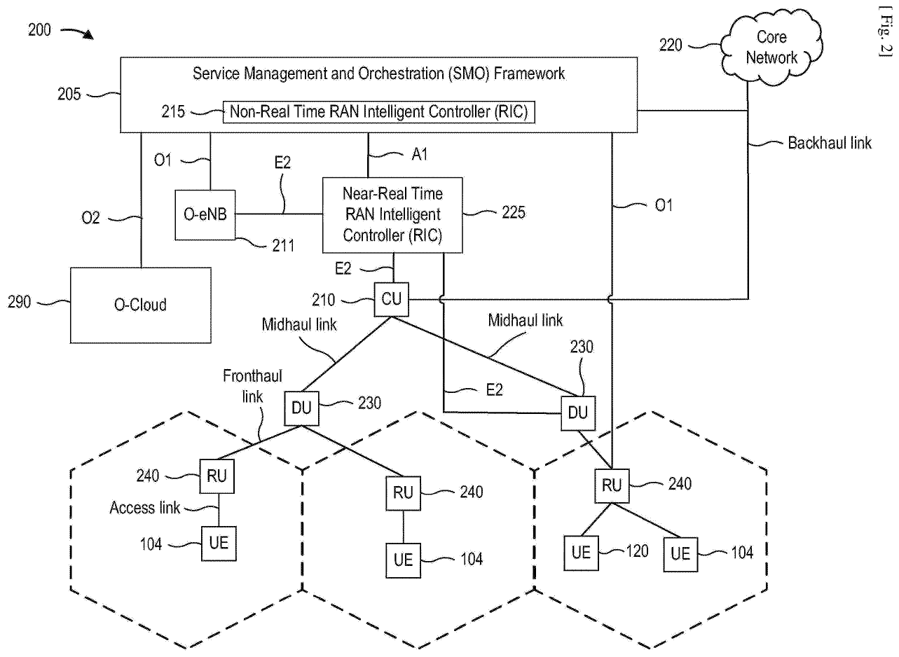

While BSs 102 are depicted in various aspects as unitary communications devices, BSs 102 may be implemented in various configurations. For example, one or more components of a BS 102 may be disaggregated, including a central unit (CU), one or more distributed units (DUs), one or more radio units (RUs), a Near-Real Time (Near-RT) RAN Intelligent Controller (RIC), or a Non-Real Time (Non-RT) RIC, to name a few examples. In another example, various aspects of a BS 102 may be virtualized. More generally, a BS (e.g., BS 102) may include components that are located at a single physical location or components located at various physical locations. In examples in which a BS 102 includes components that are located at various physical locations, the various components may each perform functions such that, collectively, the various components achieve functionality that is similar to a BS 102 that is located at a single physical location. In some aspects, a BS 102 including components that are located at various physical locations may be referred to as a disaggregated radio access network (RAN) architecture, such as an Open RAN (O-RAN) or Virtualized RAN (VRAN) architecture. FIG. 2 depicts and describes an example disaggregated BS architecture.

Different BSs 102 within wireless communications network 100 may also be configured to support different radio access technologies, such as 3G, 4G, and/ or 5G. For example, BSs 102 configured for 4G LTE (collectively referred to as Evolved Universal Mobile Telecommunications System (UMTS) Terrestrial Radio Access Network (E-UTRAN) ) may interface with the EPC 160 through first backhaul links 132 (e.g., an S1 interface). BSs 102 configured for 5G (e.g., 5G NR or Next Generation RAN (NG-RAN) ) may interface with 5GC 190 through second backhaul links 184. BSs 102 may communicate directly or indirectly (e.g., through the EPC 160 or 5GC 190) with each other over third backhaul links 134 (e.g., X2 interface), which may be wired or wireless.

Wireless communications network 100 may subdivide the electromagnetic spectrum into various classes, bands, channels, or other features. In some aspects, the subdivision is provided based on wavelength and frequency, where frequency may also be referred to as a carrier, a subcarrier, a frequency channel, a tone, or a subband. For example, 3GPP currently defines Frequency Range 1 (FR1) as including 600 MHz-6 GHz, which is often referred to (interchangeably) as “Sub-6 GHz”. Similarly, 3GPP currently defines Frequency Range 2 (FR2) as including 26-41 GHz, which is sometimes referred to (interchangeably) as a “millimeter wave” (“mmW”or “mmWave”). A BS configured to communicate using mmWave/near mm Wave radio frequency bands (e.g., a mmWave BS such as BS 180) may utilize beamforming (e.g., 182) with a UE (e.g., 104) to improve path loss and range.

The communications links 120 between BSs 102 and, for example, UEs 104, may be through one or more carriers, which may have different bandwidths (e.g., 5, 10, 15, 20, 100, 400, and/or other MHz), and which may be aggregated in various aspects.

Carriers may or may not be adjacent to each other. Allocation of carriers may be asymmetric with respect to DL and UL (e.g., more or fewer carriers may be allocated for DL than for UL).

Communications using higher frequency bands may have higher path loss and a shorter range compared to lower frequency communications. Accordingly, certain BSs (e.g., 180 in FIG. 1) may utilize beamforming 182 with a UE 104 to improve path loss and range. For example, BS 180 and the UE 104 may each include a plurality of antennas, such as antenna elements, antenna panels, and/or antenna arrays to facilitate the beamforming. In some cases, BS 180 may transmit a beamformed signal to UE 104 in one or more transmit directions 182′. UE 104 may receive the beamformed signal from the BS 180 in one or more receive directions 182″. UE 104 may also transmit a beamformed signal to the BS 180 in one or more transmit directions 182″. BS 180 may also receive the beamformed signal from UE 104 in one or more receive directions 182′. BS 180 and UE 104 may then perform beam training to determine the best receive and transmit directions for each of BS 180 and UE 104. Notably, the transmit and receive directions for BS 180 may or may not be the same. Similarly, the transmit and receive directions for UE 104 may or may not be the same.

Wireless communications network 100 further includes a Wi-Fi AP 150 in communication with Wi-Fi stations (STAs) 152 via communications links 154 in, for example, a 2.4 GHz and/or 5 GHz unlicensed frequency spectrum.

Certain UEs 104 may communicate with each other using device-to-device (D2D) communications link 158. D2D communications link 158 may use one or more sidelink channels, such as a physical sidelink broadcast channel (PSBCH), a physical sidelink discovery channel (PSDCH), a physical sidelink shared channel (PSSCH), a physical sidelink control channel (PSCCH), and/or a physical sidelink feedback channel (PSFCH).

EPC 160 may include various functional components, including: a Mobility Management Entity (MME) 162, other MMEs 164, a Serving Gateway 166, a Multimedia Broadcast Multicast Service (MBMS) Gateway 168, a Broadcast Multicast Service Center (BM-SC) 170, and/or a Packet Data Network (PDN) Gateway 172, such as in the depicted example. MME 162 may be in communication with a Home Subscriber Server (HSS) 174. MME 162 is the control node that processes the signaling between the UEs 104 and the EPC 160. Generally, MME 162 provides bearer and connection management.

Generally, user Internet protocol (IP) packets are transferred through Serving Gateway 166, which itself is connected to PDN Gateway 172. PDN Gateway 172 provides UE IP address allocation as well as other functions. PDN Gateway 172 and the BM-SC 170 are connected to IP Services 176, which may include, for example, the Internet, an intranet, an IP Multimedia Subsystem (IMS), a Packet Switched (PS) streaming service, and/or other IP services.

BM-SC 170 may provide functions for MBMS user service provisioning and delivery. BM-SC 170 may serve as an entry point for content provider MBMS transmission, may be used to authorize and initiate MBMS Bearer Services within a public land mobile network (PLMN), and/or may be used to schedule MBMS transmissions. MBMS Gateway 168 may be used to distribute MBMS traffic to the BSs 102 belonging to a Multicast Broadcast Single Frequency Network (MBSFN) area broadcasting a particular service, and/or may be responsible for session management (start/stop) and for collecting eMBMS related charging information. 5GC 190 may include various functional components, including: an Access and Mobility Management Function (AMF) 192, other AMFs 193, a Session Management Function (SMF) 194, and a User Plane Function (UPF) 195. AMF 192 may be in communication with Unified Data Management (UDM) 196.

AMF 192 is a control node that processes signaling between UEs 104 and 5GC 190. AMF 192 provides, for example, quality of service (QOS) flow and session management.

Internet protocol (IP) packets are transferred through UPF 195, which is connected to the IP Services 197, and which provides UE IP address allocation as well as other functions for 5GC 190. IP Services 197 may include, for example, the Internet, an intranet, an IMS, a PS streaming service, and/or other IP services.

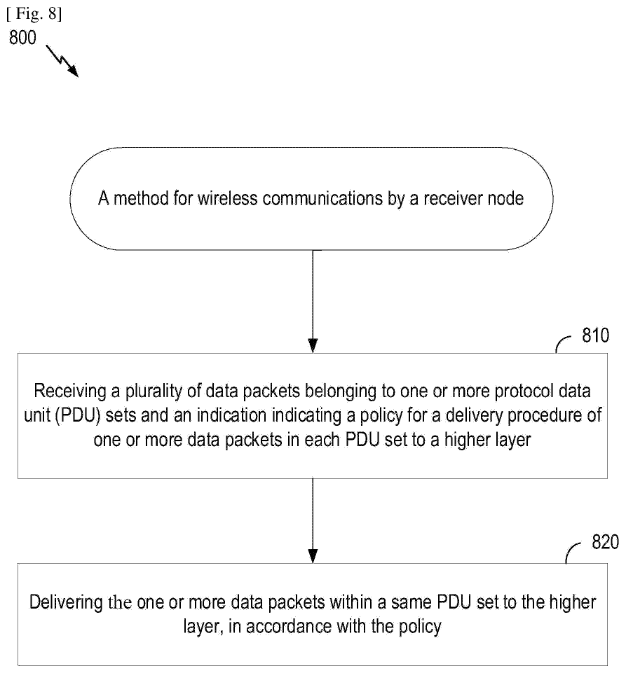

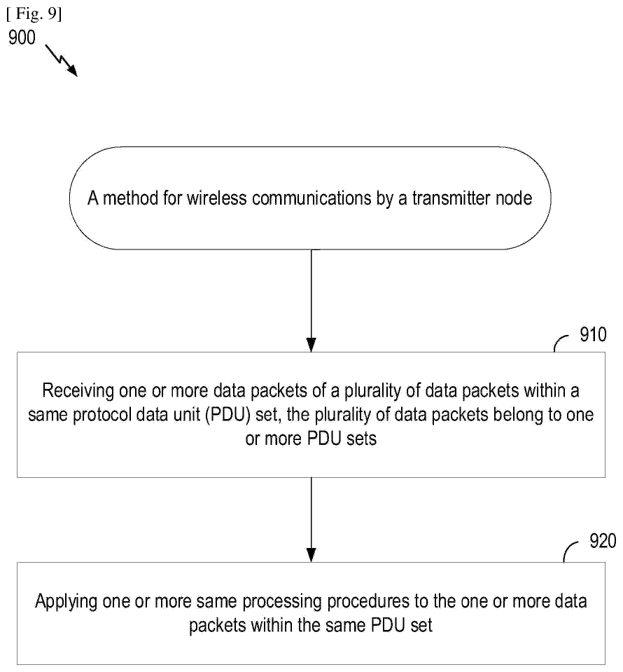

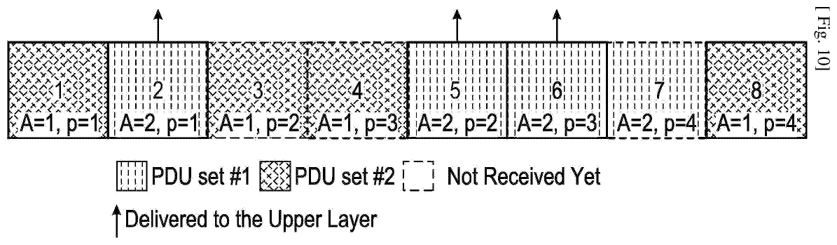

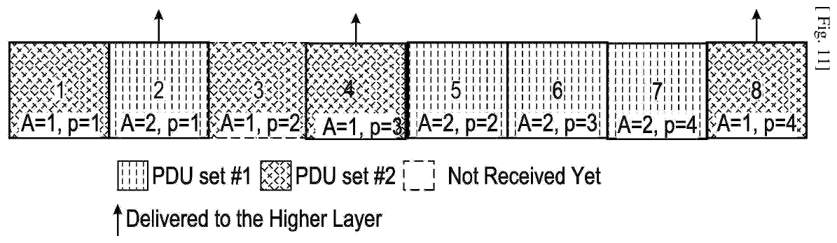

Wireless communication network 100 further includes protocol data unit (PDU) set component 198, which may be configured to perform operations 800 of FIG. 8 and/or operations 900 of FIG. 9. Wireless communication network 100 further includes PDU set component 199, which may be configured to perform operations 800 of FIG. 8 and/ or operations 900 of FIG. 9.

In various aspects, a network entity or network node can be implemented as an aggregated BS, as a disaggregated BS, a component of a BS, an integrated access and backhaul (IAB) node, a relay node, a sidelink node, to name a few examples.

FIG. 2 depicts an example disaggregated BS 200 architecture. The disaggregated BS 200 architecture may include one or more central units (CUs) 210 that can communicate directly with a core network 220 via a backhaul link, or indirectly with the core network 220 through one or more disaggregated BS units (such as a Near-Real Time (Near-RT) RAN Intelligent Controller (RIC) 225 via an E2 link, or a Non-Real Time (Non-RT) RIC 215 associated with a Service Management and Orchestration (SMO) Framework 205, or both). A CU 210 may communicate with one or more distributed units (DUs) 230 via respective midhaul links, such as an F1 interface. The DUs 230 may communicate with one or more radio units (RUs) 240 via respective fronthaul links. The RUs 240 may communicate with respective UEs 104 via one or more radio frequency (RF) access links. In some implementations, the UE 104 may be simultaneously served by multiple RUs 240.

Each of the units, e.g., the CUS 210, the DUs 230, the RUs 240, as well as the Near-RT RICs 225, the Non-RT RICs 215 and the SMO Framework 205, may include one or more interfaces or be coupled to one or more interfaces configured to receive or transmit signals, data, or information (collectively, signals) via a wired or wireless transmission medium. Each of the units, or an associated processor or controller providing instructions to the communications interfaces of the units, can be configured to communicate with one or more of the other units via the transmission medium. For example, the units can include a wired interface configured to receive or transmit signals over a wired transmission medium to one or more of the other units. Additionally or alternatively, the units can include a wireless interface, which may include a receiver, a transmitter or transceiver (such as a radio frequency (RF) transceiver), configured to receive or transmit signals, or both, over a wireless transmission medium to one or more of the other units.

In some aspects, the CU 210 may host one or more higher layer control functions. Such control functions can include radio resource control (RRC), packet data convergence protocol (PDCP), service data adaptation protocol (SDAP), or the like. Each control function can be implemented with an interface configured to communicate signals with other control functions hosted by the CU 210. The CU 210 may be configured to handle user plane functionality (e.g., Central Unit-User Plane (CU-UP) ), control plane functionality (e.g., Central Unit-Control Plane (CU-CP)), or a combination thereof. In some implementations, the CU 210 can be logically split into one or more CU-UP units and one or more CU-CP units. The CU-UP unit can communicate bidirectionally with the CU-CP unit via an interface, such as the E1 interface when implemented in an O-RAN configuration. The CU 210 can be implemented to communicate with the DU 230, as necessary, for network control and signaling.

The DU 230 may correspond to a logical unit that includes one or more BS functions to control the operation of one or more RUs 240. In some aspects, the DU 230 may host one or more of a radio link control (RLC) layer, a medium access control (MAC) layer, and one or more high physical (PHY) layers (such as modules for forward error correction (FEC) encoding and decoding, scrambling, modulation and demodulation, or the like) depending, at least in part, on a functional split, such as those defined by the 3^{rd} Generation Partnership Project (3GPP). In some aspects, the DU 230 may further host one or more low PHY layers. Each layer (or module) can be implemented with an interface configured to communicate signals with other layers (and modules) hosted by the DU 230, or with the control functions hosted by the CU 210.

Lower-layer functionality can be implemented by one or more RUs 240. In some deployments, an RU 240, controlled by a DU 230, may correspond to a logical node that hosts RF processing functions, or low-PHY layer functions (such as performing fast Fourier transform (FFT), inverse FFT (iFFT), digital beamforming, physical random access channel (PRACH) extraction and filtering, or the like), or both, based at least in part on the functional split, such as a lower layer functional split. In such an architecture, the RU(s) 240 can be implemented to handle over the air (OTA) communications with one or more UEs 104. In some implementations, real-time and non-real-time aspects of control and user plane communications with the RU(s) 240 can be controlled by the corresponding DU 230. In some scenarios, this configuration can enable the DU(s) 230 and the CU 210 to be implemented in a cloud-based RAN architecture, such as a vRAN architecture.

The SMO Framework 205 may be configured to support RAN deployment and provisioning of non-virtualized and virtualized network elements. For non-virtualized network elements, the SMO Framework 205 may be configured to support the deployment of dedicated physical resources for RAN coverage requirements which may be managed via an operations and maintenance interface (such as an O1 interface). For virtualized network elements, the SMO Framework 205 may be configured to interact with a cloud computing platform (such as an open cloud (O-Cloud) 290) to perform network element life cycle management (such as to instantiate virtualized network elements) via a cloud computing platform interface (such as an O2 interface). Such virtualized network elements can include, but are not limited to, CUs 210, DUs 230, RUs 240 and Near-RT RICs 225. In some implementations, the SMO Framework 205 can communicate with a hardware aspect of a 4G RAN, such as an open eNB (O-eNB) 211, via an O1 interface. Additionally, in some implementations, the SMO Framework 205 can communicate directly with one or more RUs 240 via an Ol interface. The SMO Framework 205 also may include a Non-RT RIC 215 configured to support functionality of the SMO Framework 205.

The Non-RT RIC 215 may be configured to include a logical function that enables non-real-time control and optimization of RAN elements and resources, Artificial Intelligence/Machine Learning (AI/ML) workflows including model training and updates, or policy-based guidance of applications/features in the Near-RT RIC 225. The Non-RT RIC 215 may be coupled to or communicate with (such as via an A1 interface) the Near-RT RIC 225. The Near-RT RIC 225 may be configured to include a logical function that enables near-real-time control and optimization of RAN elements and resources via data collection and actions over an interface (such as via an E2 interface) connecting one or more CUs 210, one or more DUs 230, or both, as well as an O-eNB, with the Near-RT RIC 225.

In some implementations, to generate AI/ML models to be deployed in the Near-RT RIC 225, the Non-RT RIC 215 may receive parameters or external enrichment information from external servers. Such information may be utilized by the Near-RT RIC 225 and may be received at the SMO Framework 205 or the Non-RT RIC 215 from non-network data sources or from network functions. In some examples, the Non-RT RIC 215 or the Near-RT RIC 225 may be configured to tune RAN behavior or performance. For example, the Non-RT RIC 215 may monitor long-term trends and patterns for performance and employ AI/ML models to perform corrective actions through the SMO Framework 205 (such as reconfiguration via O1) or via creation of RAN management policies (such as A1 policies).

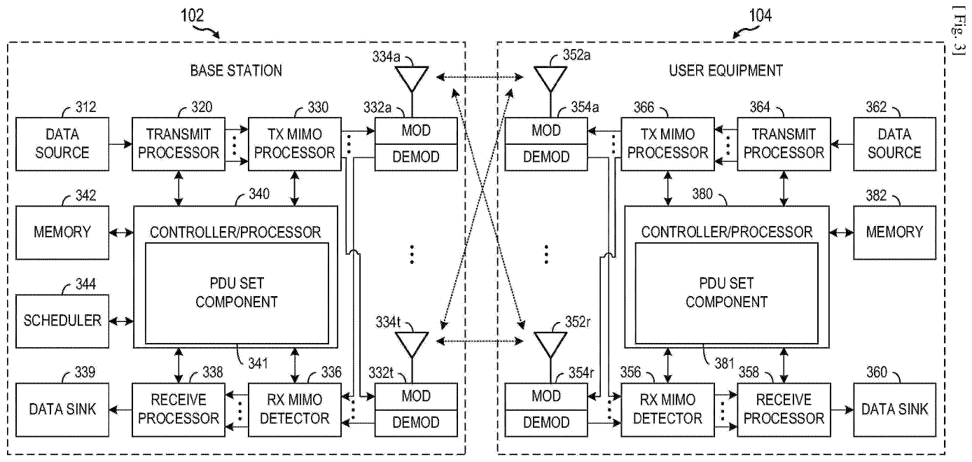

FIG. 3 depicts aspects of an example BS 102 and a UE 104.

Generally, BS 102 includes various processors (e.g., 320, 330, 338, and 340), antennas 334a-t (collectively 334), transceivers 332a-t (collectively 332), which include modulators and demodulators, and other aspects, which enable wireless transmission of data (e.g., data source 312) and wireless reception of data (e.g., data sink 339). For example, BS 102 may send and receive data between BS 102 and UE 104. BS 102 includes controller/processor 340, which may be configured to implement various functions described herein related to wireless communications.

BS 102 includes controller/processor 340, which may be configured to implement various functions related to wireless communications. In the depicted example, controller/processor 340 includes PDU set component 341, which may be representative of PDU set component 199 of FIG. 1. Notably, while depicted as an aspect of controller/processor 340, PDU set component 241 may be implemented additionally or alternatively in various other aspects of BS 102 in other implementations.

Generally, UE 104 includes various processors (e.g., 358, 364, 366, and 380), antennas 352a-r (collectively 352), transceivers 354a-r (collectively 354), which include modulators and demodulators, and other aspects, which enable wireless transmission of data (e.g., retrieved from data source 362) and wireless reception of data (e.g., provided to data sink 360). UE 104 includes controller/processor 380, which may be configured to implement various functions described herein related to wireless communications.

UE 104 includes controller/processor 380, which may be configured to implement various functions related to wireless communications. In the depicted example, controller/processor 380 includes PDU set component 381, which may be representative of PDU set component 198 of FIG. 1. Notably, while depicted as an aspect of controller/processor 380, PDU set component 381 may be implemented additionally or alternatively in various other aspects of UE 104 in other implementations.

In regards to an example downlink transmission, BS 102 includes a transmit processor 320 that may receive data from a data source 312 and control information from a controller/processor 340. The control information may be for the physical broadcast channel (PBCH), physical control format indicator channel (PCFICH), physical HARQ indicator channel (PHICH), physical downlink control channel (PDCCH), group common PDCCH (GC PDCCH), and/or others. The data may be for the physical downlink shared channel (PDSCH), in some examples.

Transmit processor 320 may process (e.g., encode and symbol map) the data and control information to obtain data symbols and control symbols, respectively. Transmit processor 320 may also generate reference symbols, such as for the primary synchronization signal (PSS), secondary synchronization signal (SSS), PBCH demodulation reference signal (DMRS), and channel state information reference signal (CSI-RS).

Transmit (TX) multiple-input multiple-output (MIMO) processor 330 may perform spatial processing (e.g., precoding) on the data symbols, the control symbols, and/ or the reference symbols, if applicable, and may provide output symbol streams to the modulators (MODs) in transceivers 332a-332t. Each modulator in transceivers 332a-332t may process a respective output symbol stream to obtain an output sample stream. Each modulator may further process (e.g., convert to analog, amplify, filter, and upconvert) the output sample stream to obtain a downlink signal. Downlink signals from the modulators in transceivers 332a-332t may be transmitted via the antennas 334a-334t, respectively.

In order to receive the downlink transmission, UE 104 includes antennas 352a-352r that may receive the downlink signals from the BS 102 and may provide received signals to the demodulators (DEMODs) in transceivers 354a-354r, respectively. Each demodulator in transceivers 354a-354r may condition (e.g., filter, amplify, downconvert, and digitize) a respective received signal to obtain input samples. Each demodulator may further process the input samples to obtain received symbols.

MIMO detector 356 may obtain received symbols from all the demodulators in transceivers 354a-354r, perform MIMO detection on the received symbols if applicable, and provide detected symbols. Receive processor 358 may process (e.g., demodulate, deinterleave, and decode) the detected symbols, provide decoded data for the UE 104 to a data sink 360, and provide decoded control information to a controller/ processor 380.

In regards to an example uplink transmission, UE 104 further includes a transmit processor 364 that may receive and process data (e.g., for the PUSCH) from a data source 362 and control information (e.g., for the physical uplink control channel (PUCCH) ) from the controller/processor 380. Transmit processor 364 may also generate reference symbols for a reference signal (e.g., for the sounding reference signal (SRS) ). The symbols from the transmit processor 364 may be precoded by a TX MIMO processor 366 if applicable, further processed by the modulators in transceivers 354a-354r (e.g., for SC-FDM), and transmitted to BS 102.

At BS 102, the uplink signals from UE 104 may be received by antennas 334a-t, processed by the demodulators in transceivers 332a-332t, detected by a MIMO detector 336 if applicable, and further processed by a receive processor 338 to obtain decoded data and control information sent by UE 104. Receive processor 338 may provide the decoded data to a data sink 339 and the decoded control information to the controller/ processor 340.

Memories 342 and 382 may store data and program codes for BS 102 and UE 104, respectively.

Scheduler 344 may schedule UEs for data transmission on the downlink and/or uplink.

In various aspects, BS 102 may be described as transmitting and receiving various types of data associated with the methods described herein. In these contexts, “transmitting” may refer to various mechanisms of outputting data, such as outputting data from data source 312, scheduler 344, memory 342, transmit processor 320, controller/processor 340, TX MIMO processor 330, transceivers 332a-t, antenna 334a-t, and/or other aspects described herein. Similarly, “receiving” may refer to various mechanisms of obtaining data, such as obtaining data from antennas 334a-t, transceivers 332a-t, RX MIMO detector 336, controller/processor 340, receive processor 338, scheduler 344, memory 342, and/or other aspects described herein.

In various aspects, UE 104 may likewise be described as transmitting and receiving various types of data associated with the methods described herein. In these contexts, “transmitting” may refer to various mechanisms of outputting data, such as outputting data from data source 362, memory 382, transmit processor 364, controller/processor 380, TX MIMO processor 366, transceivers 354a-t, antenna 352a-t, and/or other aspects described herein. Similarly, “receiving” may refer to various mechanisms of obtaining data, such as obtaining data from antennas 352a-t, transceivers 354a-t, RX MIMO detector 356, controller/processor 380, receive processor 358, memory 382, and/or other aspects described herein.

In some aspects, a processor may be configured to perform various operations, such as those associated with the methods described herein, and transmit (output) to or receive (obtain) data from another interface that is configured to transmit or receive, respectively, the data.

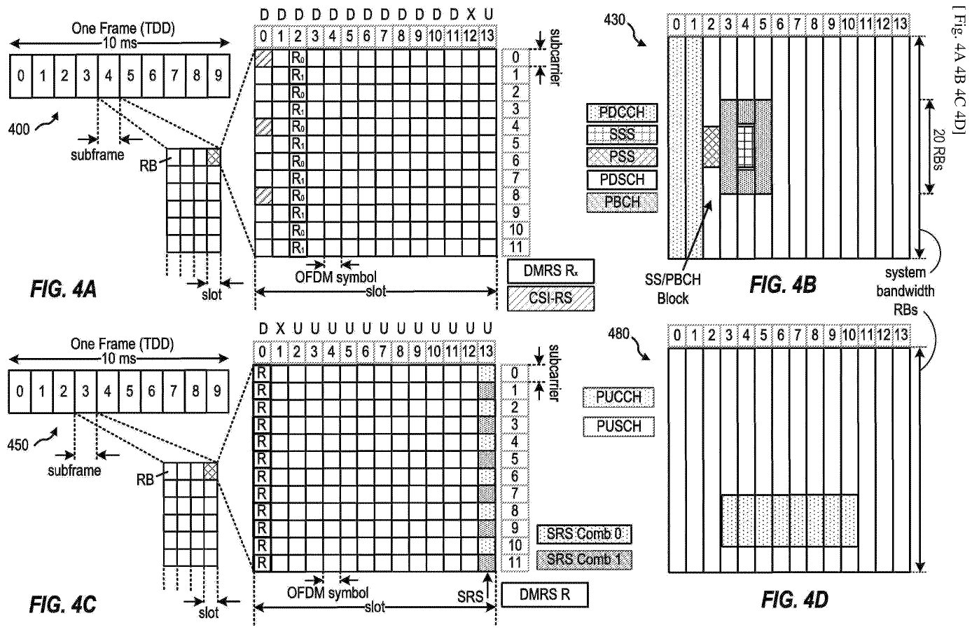

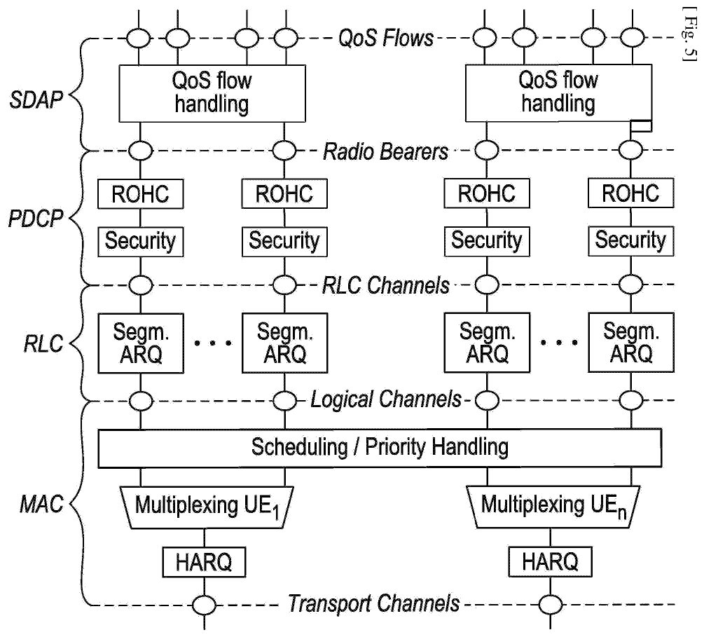

FIGS. 4A, 4B, 4C, and 4D depict aspects of data structures for a wireless communications network, such as wireless communications network 100 of FIG. 1.

In particular, FIG. 4A is a diagram 400 illustrating an example of a first subframe within a 5G (e.g., 5G NR) frame structure, FIG. 4B is a diagram 430 illustrating an example of DL channels within a 5G subframe, FIG. 4C is a diagram 450 illustrating an example of a second subframe within a 5G frame structure, and FIG. 4D is a diagram 480 illustrating an example of UL channels within a 5G subframe.

Wireless communications systems may utilize orthogonal frequency division multiplexing (OFDM) with a cyclic prefix (CP) on the uplink and downlink. Such systems may also support half-duplex operation using time division duplexing (TDD). OFDM and single-carrier frequency division multiplexing (SC-FDM) partition the system bandwidth (e.g., as depicted in FIGS. 4B and 4D) into multiple orthogonal subcarriers. Each subcarrier may be modulated with data. Modulation symbols may be sent in the frequency domain with OFDM and/or in the time domain with SC-FDM.

A wireless communications frame structure may be frequency division duplex (FDD), in which, for a particular set of subcarriers, subframes within the set of subcarriers are dedicated for either DL or UL. Wireless communications frame structures may also be time division duplex (TDD), in which, for a particular set of subcarriers, subframes within the set of subcarriers are dedicated for both DL and UL.

In FIGS. 4A and 4C, the wireless communications frame structure is TDD where D is DL, U is UL, and X is flexible for use between DL/UL. UEs may be configured with a slot format through a received slot format indicator (SFI) (dynamically through DL control information (DCI), or semi-statically/statically through radio resource control (RRC) signaling). In the depicted examples, a 10 ms frame is divided into 10 equally sized 1 ms subframes. Each subframe may include one or more time slots. In some examples, each slot may include 7 or 14 symbols, depending on the slot format. Subframes may also include mini-slots, which generally have fewer symbols than an entire slot. Other wireless communications technologies may have a different frame structure and/or different channels.

In certain aspects, the number of slots within a subframe is based on a slot configuration and a numerology. For example, for slot configuration 0, different numerologies (μ) 0 to 5 allow for 1, 2, 4, 8, 16, and 32 slots, respectively, per subframe. For slot configuration 1, different numerologies 0 to 2 allow for 2, 4, and 8 slots, respectively, per subframe. Accordingly, for slot configuration 0 and numerology μ, there are 14 symbols/slot and 2 μ slots/subframe. The subcarrier spacing and symbol length/duration are a function of the numerology. The subcarrier spacing may be equal to 2^{μ}×15 kHz, where μ is the numerology 0 to 5. As such, the numerology μ=0 has a subcarrier spacing of 15 kHz and the numerology μ=5 has a subcarrier spacing of 480 kHz. The symbol length/duration is inversely related to the subcarrier spacing. FIGS. 4A, 4B, 4C, and 4D provide an example of slot configuration 0 with 14 symbols per slot and numerology μ=2 with 4 slots per subframe. The slot duration is 0.25 ms, the subcarrier spacing is 60 kHz, and the symbol duration is approximately 16.67 μs.

As depicted in FIGS. 4A, 4B, 4C, and 4D, a resource grid may be used to represent the frame structure. Each time slot includes a resource block (RB) (also referred to as physical RBs (PRBs) ) that extends, for example, 12 consecutive subcarriers. The resource grid is divided into multiple resource elements (REs). The number of bits carried by each RE depends on the modulation scheme.

As illustrated in FIG. 4A, some of the REs carry reference (pilot) signals (RS) for a UE (e.g., UE 104 of FIGS. 1 and 3). The RS may include demodulation RS (DMRS) and/or channel state information reference signals (CSI-RS) for channel estimation at the UE. The RS may also include beam measurement RS (BRS), beam refinement RS (BRRS), and/or phase tracking RS (PT-RS).

FIG. 4B illustrates an example of various DL channels within a subframe of a frame. The physical downlink control channel (PDCCH) carries DCI within one or more control channel elements (CCEs), each CCE including, for example, nine RE groups (REGs), each REG including, for example, four consecutive REs in an OFDM symbol.

A primary synchronization signal (PSS) may be within symbol 2 of particular subframes of a frame. The PSS is used by a UE (e.g., 104 of FIGS. 1 and 3) to determine subframe/symbol timing and a physical layer identity.

A secondary synchronization signal (SSS) may be within symbol 4 of particular subframes of a frame. The SSS is used by a UE to determine a physical layer cell identity group number and radio frame timing.

Based on the physical layer identity and the physical layer cell identity group number, the UE can determine a physical cell identifier (PCI). Based on the PCI, the UE can determine the locations of the aforementioned DMRS. The physical broadcast channel (PBCH), which carries a master information block (MIB), may be logically grouped with the PSS and SSS to form a synchronization signal (SS)/PBCH block. The MIB provides a number of RBs in the system bandwidth and a system frame number (SFN). The physical downlink shared channel (PDSCH) carries user data, broadcast system information not transmitted through the PBCH such as system information blocks (SIBs), and/or paging messages.

As illustrated in FIG. 4C, some of the REs carry DMRS (indicated as R for one particular configuration, but other DMRS configurations are possible) for channel estimation at the BS. The UE may transmit DMRS for the PUCCH and DMRS for the PUSCH. The PUSCH DMRS may be transmitted, for example, in the first one or two symbols of the PUSCH. The PUCCH DMRS may be transmitted in different configurations depending on whether short or long PUCCHs are transmitted and depending on the particular PUCCH format used. UE 104 may transmit sounding reference signals (SRS). The SRS may be transmitted, for example, in the last symbol of a subframe. The SRS may have a comb structure, and a UE may transmit SRS on one of the combs. The SRS may be used by a BS for channel quality estimation to enable frequency-dependent scheduling on the UL.

FIG. 4D illustrates an example of various UL channels within a subframe of a frame. The PUCCH may be located as indicated in one configuration. The PUCCH carries uplink control information (UCI), such as scheduling requests, a channel quality indicator (CQI), a precoding matrix indicator (PMI), a rank indicator (RI), and HARQ ACK/NACK feedback. The PUSCH carries data, and may additionally be used to carry a buffer status report (BSR), a power headroom report (PHR), and/or UCI.

### Example Quality of Service (QOS)

Quality of service (QOS) refers to a measurement of overall performance of a service experienced by users of a network. To quantitatively measure QoS packet loss, bit rate, throughput, transmission delay, availability, etc. related aspects of the service are considered. QoS includes requirements on all aspects of a connection, such as service response time, loss, signal-to-noise ratio, crosstalk, echo, interrupts, frequency response, and/or loudness levels.

In 5G new radio (NR), QOS is enforced at a QoS flow level. Each QoS flow packets (e.g., data packets) are classified and marked using QoS flow identifier (QFI). For example, a first QoS flow is associated with video packets (e.g., WhatsApp video and Skype video) and a second QoS flow is associated with video streaming packets (e.g., YouTube video stream). The one or more QoS flows are mapped in an access network to one or more data radio bearers (DRBs). For example, a DRB transports packets of an evolved packet system (EPS) bearer between a user equipment (UE) and a network entity.

Within the 5G network, 5G QoS identifier (5QI) mechanism may be used in which packets are classified into different QoS classes. In this way, the QoS can be tailored to specific requirements. Each QoS class has its own assigned QoS characteristics (e.g., such as packet delay and packet loss). Accordingly, some packets can get better QoS than other packets.

The network entity maps individual QoS flows to one or more DRBs. A protocol data unit (PDU) session may contain multiple QoS flows and several DRBs. For example, the PDU session provides end-to-end user-plane connectivity between the UE and a specific data network through user-plane function (UPF). The PDU session supports one or more QoS flows, and a DRB transports the one or more QoS flows.

The network entity provides the UE with one or more QoS flow descriptions associated with the PDU session at the PDU session establishment or at the PDU session modification. Each QoS flow description may include a) a QFI; b) if the QoS flow is a guaranteed bit rate (GBR) QoS flow: 1) guaranteed flow bit rate (GFBR) for uplink, 2) GFBR for downlink, 3) maximum flow bit rate (MFBR) for uplink, 4) MFBR for downlink and/or 5) averaging window applicable for both uplink and downlink, or if the QoS flow is a non-GBR QoS flow: 1) reflective QoS attribute (RQA) in downlink and/or 2) additional QoS flow information; c) 5G QoS identifier (5QI) if the QFI is not the same as the 5QI of the QoS flow identified by the QFI; d) allocation and retention priority (ARP), and/or e) an EPS bearer identity (EBI) if the QOS flow can be mapped to an EPS bearer. All packets belonging to a specific QoS flow has a same 5QI.

The network entity provides the UE with QoS rules associated with the PDU session. The QoS rules may be provided at the PDU session establishment or at the PDU session modification. Each QoS rule includes an indication of whether the QoS rule is a default QoS rule, a QoS rule identifier (QRI), a QFI, a set of packet filters, and/or a precedence value.

### Example Layer 2 (L2) of New Radio (NR) Protocol Stock

New radio (NR) radio protocol stack has two categories: 1) control-plane stack, and 2) user-plane stack. If data corresponds to signaling or controlling message, then the data is sent through the control-plane. User data is sent through the user-plane.

As illustrated in FIG. 5, user-plane protocol stock (e.g., layer 2 (L2) ) of NR is split into sub layers such as a service data adaptation protocol (SDAP) layer, a packet data convergence protocol (PDCP) layer, a radio link control (RLC) layer, and a medium access control (MAC) layer. In NR, carrier aggregation is supported, and data for each carrier may be processed independently in the SDAP layer, the PDCP layer, the RLC layer and is multiplexed in the MAC layer.

The SDAP layer may perform mapping between a quality of service (QOS) flow (e.g., associated with one or more data packets (e.g., protocol data units (PDUs) ) and a data radio bearer (DRB) (e.g., due to QoS framework). The SDAP layer may also perform marking QOS flow ID (QFI) in both downlink and uplink packets (e.g., downlink due to reflective QoS and uplink due to QoS framework). A single protocol entity of SDAP is configured for each individual protocol data unit (PDU) session.

The PDCP layer may perform header compression and decompression of internet protocol (IP) data (e.g., robust header compression (ROHC)), maintain PDCP sequence numbers (SNs), perform in-sequence delivery of upper layer PDUs at re-establishment of lower layers, perform reordering and eliminate duplicates of lower layer service data units (SDUs), execute PDCP PDU routing for the case of split bearers, execute retransmission of lower layer SDUs, cipher and decipher control plane and user-plane data, perform integrity protection and integrity verification of control plane and user plane data, control timer-based discard of data, and perform security operations (e.g., ciphering, deciphering, integrity protection, integrity verification, etc.).

The RLC layer may operate in a plurality of modes of operation including transparent mode (TM), unacknowledged mode (UM), and acknowledged mode (AM). The RLC layer may perform transfer of upper layer PDUs error correction through automatic repeat request (ARQ) for AM data transfers, and segmentation and reassembly of RLC SDUs for UM and AM data transfers. The RLC layer may maintain SNs independent of the ones in PDCP for UM and AM data transfers. The RLC layer may perform resegmentation of RLC data PDUs for AM data transfers, detect duplicate data for AM data transfers, discard RLC SDUs for UM and AM data transfers, detect protocol errors for AM data transfers, and/or perform RLC re-establishment.

The MAC layer may perform mapping between logical channels and transport channels, multiplexing of MAC SDUs from one or more logical channels onto transport blocks (TB) to be delivered to a physical layer (PHY) via transport channels, de-multiplexing MAC SDUs to one or more logical channels from TB delivered from the PHY via the transport channels, scheduling information reporting, error correction through hybrid automatic repeat request (HARQ), priority handling between UEs by means of dynamic scheduling, priority handling between logical channels of one UE by means of logical channel prioritization, and/or padding.

### Example Extended Reality (XR) Applications and Protocol Data Unit (PDU) Sets

An extended reality (XR) application may include a virtual reality (VR) application, an augmented reality (AR) application, and/or a mixed reality (MR) application. The XR application generates and consumes in data units, which are larger (e.g., in size) than internet protocol (IP) packets (e.g., data packets). The data units are called protocol data unit (PDU) sets. A PDU set is also known as an application data unit (ADU). The PDU sets are segmented into the data packets when the PDU sets are transmitted over a core network (CN). Although the data packets of each PDU set typically arrive at a receiver around a same time, however, in some cases, the data packets of each PDU set may not arrive at the same time. Also, all data packets in a PDU set may have same quality of service (QOS) requirements.

There are two types of PDU sets. One type of the PDU set is called a type-A PDU set, and another type of the PDU SET is called a type-B PDU set. With regards to the type-A PDU set (e.g., all or nothing PDU set), if any data packet in the type-A PDU set is lost (e.g., during transmission) or misses a deadline (e.g., associated with its QoS requirements), then remaining data packets in the type-A PDU set become useless.

With regards to the type-B PDU set, a reception of the type-B PDU set is considered to be successful when a decoding criterion is met (e.g., a predetermined number of data packets or bytes of the type-B PDU set are received).

Current layer 2 (L2) procedures (e.g., a PDCP layer procedure, a MAC layer procedure, etc.) are configured and performed on basis of individual data packets (and associated QoS requirements), and not PDU sets. That is, different L2 procedures are applied on different data packets, and the different data packets maybe processed separately. However, in an PDU set, all data packets of the PDU set have same QoS requirements and have to be processed together. This is because if any data packet of the PDU set does not meet its QoS deadline, then remaining data packets of the PDU set become useless and the PDU set has to be discarded. Accordingly, there is a need for enhancements in the L2 procedures to support PDU set-based scheduling (e.g., to manage processing (e.g., jointly or separately) of the data packets of the PDU set).

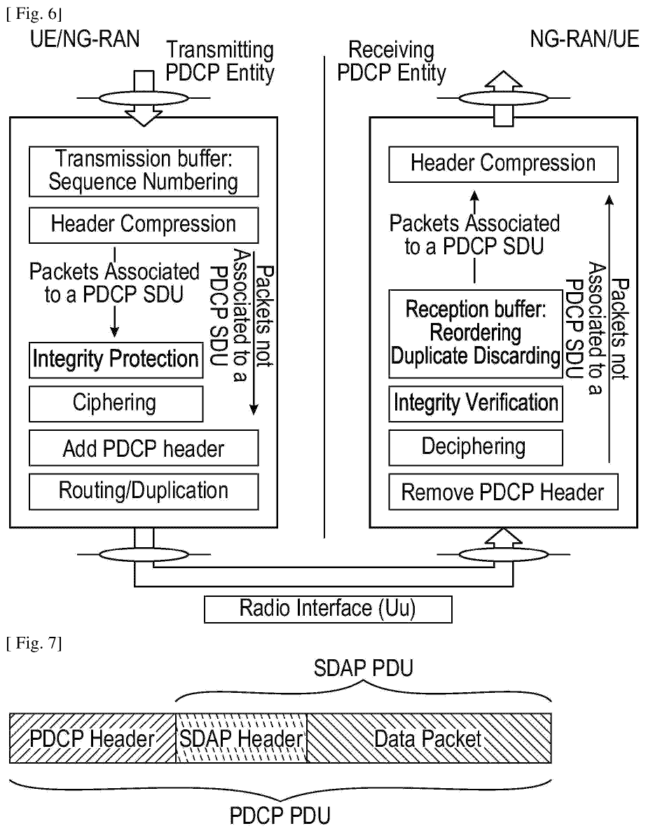

As noted above and illustrated in FIG. 6, per the current L2 procedure, when a data packet (or an Ethernet frame) arrives at a radio access network (RAN), the RAN first performs QoS mapping to classify the data packet into a data radio bearer (DRB) in a service data adaptation protocol (SDAP) layer. The RAN then packages the data packet (i.e., SDAP PDU) into a packet data convergence protocol (PDCP) PDU. The PDCP layer procedures performed in assembly of the PDCP PDU include sequence numbering, robust header compression (ROHC), integrity protection, ciphering, and adding of a PDCP header.

Currently, as illustrated in FIG. 7, one SDAP PDU is mapped to a single PDCP PDU, and there is no multiplexing of multiple SDAP PDUs into the single PDCP PDU. However, in some applications (e.g., the XR application), a set of data packets of a PDU set have to be delivered at the same time (e.g., all or nothing PDU set). Accordingly, there is a need to enable aggregation of the set of data packets (e.g., the set of SDAP PDUs) and handled as the single PDCP PDU for the L2 procedures.

Aspects Related to Protocol Data Unit (PDU) Set based User-Plane Procedures

Aspects of the present disclosure provide apparatuses, methods, processing systems, and computer-readable mediums for layer 2 (L2) procedures for protocol data unit (PDU) set based scheduling.

Current L2 procedures are configured and performed on basis of individual data packets and not on multiple data packets belonging to a same PDU set. That is, different L2 procedures are applied on different data packets and the different data packets maybe processed separately. The present application describes enhancements in the L2 procedures to support the PDU set-based scheduling, to achieve successful processing (e.g., jointly or separately) of the data packets of the PDU set. For example, the enhancements to the L2 procedures may enable determining the data packets that belong to the same PDU set and subsequent application of same processing procedures on the data packets of the same PDU set. The L2 procedures proposed herein are able to meet same quality of service (QOS) requirements of the data packets of the PDU set during the processing of the data packets.

The L2 procedures for the PDU set-based scheduling proposed herein may be understood with reference to the FIGS. 8-18.

FIG. 8 illustrates example operations 800 for wireless communication. The operations 800 may be performed, for example, by a receiver node (e.g., such as UE 104 in wireless communication network 100 of FIG. 1). The operations 800 may be implemented as software components that are executed and run on one or more processors (e.g., controller/processor 380 of FIG. 3). Further, transmission and reception of signals by the receiver node in the operations 800 may be enabled, for example, by one or more antennas (e.g., antennas 352 of FIG. 3). In certain aspects, the transmission and/or reception of signals by the receiver node may be implemented via a bus interface of one or more processors (e.g., the controller/processor 380) obtaining and/or outputting signals.

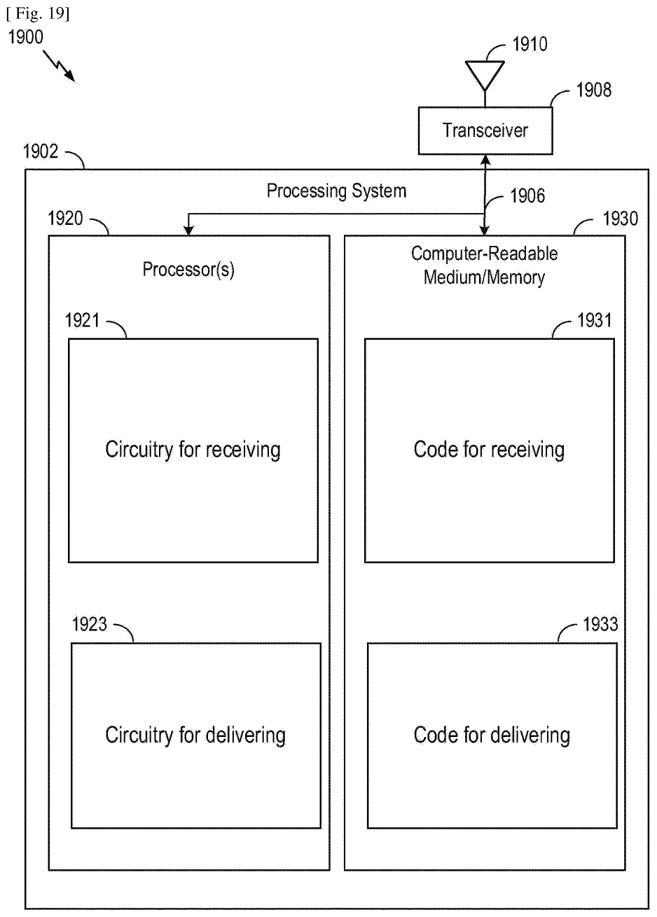

The operations 800 begin, at 810, by receiving a plurality of data packets belonging to one or more PDU sets and an indication indicating a policy for a delivery procedure of one or more data packets in each PDU set to a higher layer. For example, the receiver node may receive the plurality of data packets and the indication, using antenna(s) and/or receiver/transceiver components of UE 104 shown in FIG. 1 or FIG. 3 and/or of the apparatus shown in FIG. 19.

At 820, the receiver node delivers the one or more data packets within a same PDU set to the higher layer, in accordance with the policy. For example, the receiver node may deliver the one or more data packets within the same PDU set to the higher layer, using a processor of UE 104 shown in FIG. 1 or FIG. 3 and/or of the apparatus shown in FIG. 19.

Note that FIG. 8 is just one example of a method, and other methods including fewer, additional, or alternative steps are possible consistent with this disclosure.

FIG. 9 illustrates example operations 900 for wireless communication. The operations 900 may be performed, for example, by a transmitter node (e.g., such as UE 104 in wireless communication network 100 of FIG. 1). The operations 900 may be implemented as software components that are executed and run on one or more processors (e.g., controller/processor 380 of FIG. 3). Further, transmission and reception of signals by the transmitter node in the operations 900 may be enabled, for example, by one or more antennas (e.g., antennas 352 of FIG. 3). In certain aspects, the transmission and/or reception of signals by the transmitter node may be implemented via a bus interface of one or more processors (e.g., the controller/processor 380) obtaining and/or outputting signals.

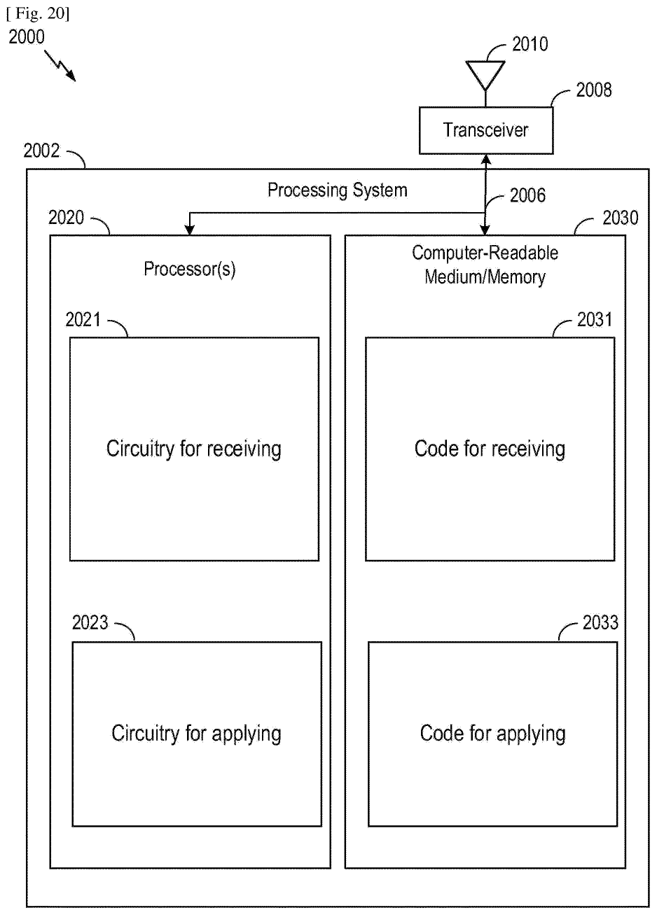

The operations 900 begin, at 910, by receiving one or more data packets of a plurality of data packets within a same PDU set. The plurality of data packets belong to one or more PDU sets. For example, the transmitter node may receive the one or more data packets of the plurality of data packets within the same PDU set, using antenna(s) and/ or receiver/transceiver components of UE 104 shown in FIG. 1 or FIG. 3 and/or of the apparatus shown in FIG. 20.

At 920, the transmitter node applies one or more same processing procedures to the one or more data packets within the same PDU set. For example, the transmitter node may apply the one or more same processing procedures to the one or more data packets within the same PDU set, using a processor of UE 104 shown in FIG. 1 or FIG. 3 and/ or of the apparatus shown in FIG. 20.

Note that FIG. 9 is just one example of a method, and other methods including fewer, additional, or alternative steps are possible consistent with this disclosure.

In certain aspects, the receiver node receives the plurality of data packets belonging to the one or more PDU sets at a service data adaption protocol (SDAP) layer. In certain aspects, the receiver node then determines whether an PDU set of the one or more PDU sets is a type-A PDU set or a type-B PDU set (e.g., based on the policy, which indicates a type of each PDU set of the one or more PDU sets).

In certain aspects, the one or more data packets within the same PDU set are processed in a same manner, in accordance with the policy (e.g., the policy may indicate a processing procedure of the one or more data packets in each PDU set). For example, all data packets in the same PDU set may be routed to a same packet data convergence protocol (PDCP) entity. For example, the receiver node may map each data packet within the same PDU set to a single PDCP protocol data unit (PDU) (i.e., aggregation of the data packets in the same PDU set into the single PDCP PDU when the data packets arrive around the same time).

In certain aspects, the receiver node determines to not deliver multiple data packets of a same type-A PDU set to the higher layer, until all data packets of the same type-A PDU set are received. For example, PDUs belonging to the same type-A PDU set in a reordering buffer at a PDCP entity are not delivered to an upper layer unless all the PDUs have been received (e.g., from a lower layer in the reordering buffer at the PDCP entity). The completion of the type-A PDU set (i.e., all data packets of the type-A PDU set have been received) can be indicated by a last-data packet indicator in an PDU set header.

In certain aspects, the receiver node determines to discard all data packets in the PDU set, when any data packet in the PDU set reaches a packet delay budget (PDB) limit. For example, when any PDU in the same type-A PDU set or the type-B PDU set reaches its PDB limit while in the reordering buffer at the PDCP entity, then all PDUs in the same type-A PDU set or the type-B PDU set (e.g., including future arrivals) are discarded.

In certain aspects, the receiver node delivers the type-B PDU set to the higher layer, when at least a predetermined number of data packets or bytes (e.g., according to the policy) of the type-B PDU set are received in the reordering buffer at the PDCP entity. For example, once a decoding criterion is met (e.g., X % of data packets or bytes of the type-B PDU set are received), the type-B PDU set is considered complete and delivered to the upper layer. The remaining data packets of the type-B PDU set that may arrive at a later time are discarded. In certain aspects, the decoding criterion may be signaled in the PDU set header.

In certain aspects, the receiver node delivers the plurality of data packets belonging to the one or more PDU sets to the higher layer, based on an PDU set instead of a PDCP PDU, when a data radio bearer (DRB) is configured for an out-of-order delivery of the plurality of data packets at the PDCP entity. That is, the PDCP PDU can not be delivered out-of-order unless the decoding criterion for the PDU set has been met (e.g., all data packets in the type-A PDU set have been received).

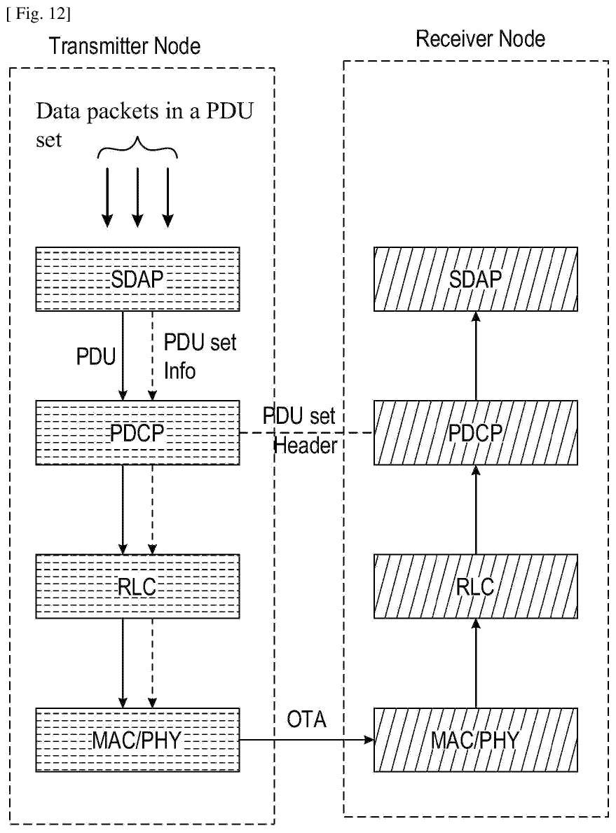

As illustrated in FIG. 10, a first PDU, a third PDU, a fourth PDU, and an eight PDU belong to a first PDU set. A second PDU, a fifth PDU, a sixth PDU, and a seventh PDU belong to a second PDU set. During L2 procedure PDU set-based PDCP out-of-order delivery operation, the first PDU, second PDU, the fifth PDU, the sixth PDU, and the eight PDU are received in a receiver buffer. At this time, the third PDU, the fourth PDU, and the seventh PDU have yet not been received. Since the second PDU, the fifth PDU, and the sixth PDU are in a sequence (and belong to the same second PDU set), the second PDU, the fifth PDU, and the sixth PDU can be delivered to an upper layer even when the third PDU and the fourth PDU are not received in the receiver buffer. This may allow the PDUs in a more delay sensitive QoS flow not to be blocked by other PDUs in front of them.

In certain aspects, all data packets (or PDUs) within the same PDU set are associated with a common discard timer, irrespective of arrival time of the data packets. In such cases, upon expiry of the common discard timer, a radio link control (RLC) layer is instructed (e.g., by other layers) to discard all the data packets associated with the same PDU set.

In certain aspects, the transmitter node routes all data packets within the same PDU set to a same uplink (UL) split bearer (e.g., even when data volume crosses a predetermined routing threshold within the PDU set).

In certain aspects, the receiver node delivers the plurality of data packets belonging to the one or more PDU sets to the higher layer, based on an PDU set instead of a PDCP PDU, when a DRB is configured for an in-order delivery of the one or more PDU sets at a PDCP entity.

In certain aspects, a packet order within an PDU set is not required (e.g., for the type-B PDU set). For example, the one or more PDU sets may include a first PDU set and a second PDU set. The second PDU set may not be delivered to the higher layer until all data packets of the first PDU set are received, based on the in-order delivery process. However, the data packets in the first PDU set can be delivered out-of-order to the higher layer.

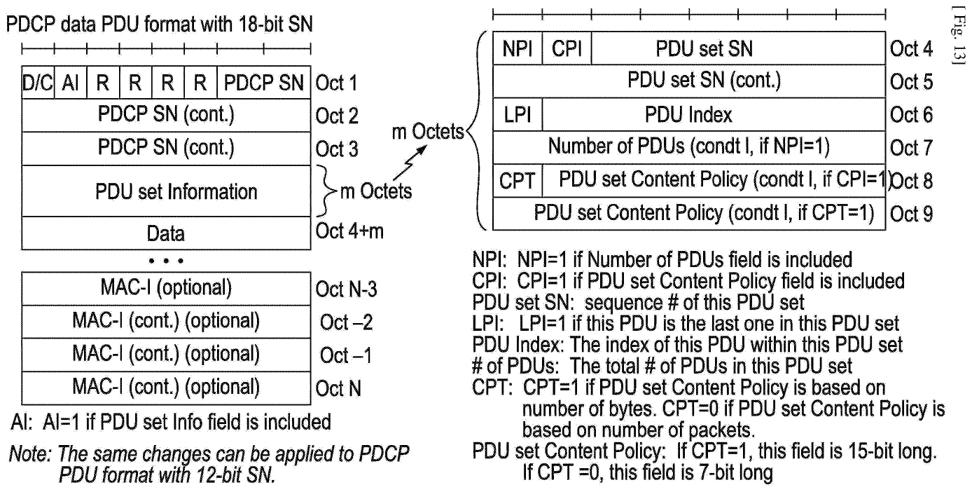

As illustrated in FIG. 11, a first PDU, a third PDU, a fourth PDU, and an eighth PDU belong to a first PDU set. A second PDU, a fifth PDU, a sixth PDU, and a seventh PDU belong to a second PDU set. During L2 procedure PDU set-based PDCP in-order delivery operation, the first PDU, second PDU, the fourth PDU, the fifth PDU, the sixth PDU, the seventh PDU, and the eighth PDU are received in a receiver buffer. At this time, the third PDU has yet not been received. So, the first PDU set is yet not complete. Although the first PDU set is yet not complete, however, the first PDU, the fourth PDU, and the eighth PDU of the first PDU set can be delivered to the higher layer (e.g., since the first PDU set is first in the receiver buffer). Furthermore, although the second PDU set is complete since all the data packets of the second PDU set have been received, however, the second PDU set can not be delivered to the higher layer until the first PDU set is complete (i.e., the third PDU is received).

In certain aspects, one or more RLC procedures can be performed on data packets (or PDUs) based on individual PDUs, independent from their PDU set association. For example, at an RLC layer, a conventional reassembly operation may be applied on RLC PDUs and PDU set-level reassembly is left to a PDCP layer. Furthermore, the RLC PDUs with a sequence number outside a window of the receiver node may be discarded individually.

In certain aspects, when the RLC layer receives PDU set discard indication associated with a particular PDU set from the PDCP layer, the transmitter node may discard all PDUs in a transmitter buffer for said PDU set. The receiver node may discard all PDUs in a reassembly buffer and ignore future arrivals (if any) of data packets in said PDU set.

In certain aspects, the receiver node may discard an RLC data packet in a type-A PDU set at the RLC layer (e.g., when the RLC data packet reaches a L2 deadline). The discarding of the RLC data packet may trigger discarding of other data packets in the type-A PDU set (e.g., in a PDCP or a MAC layer buffer). For example, the discarding of other PDUs in the same type-A PDU set that are already in the PDCP reordering buffer. In another example, the discarding of MAC PDUs that may contain MAC sub-PDUs associated with the same type-A PDU set. In certain aspects, the discarding of the RLC data packet may trigger transmission of a status of the RLC data packet (e.g., RCL Status PDU) to the transmitter UE (e.g., subject to a separate t-StatusProhibit timer).

In certain aspects, it may be more efficient to schedule MAC PDUs individually, regardless of their affiliation with any PDU sets. However, in some other cases (e.g., when a deadline-based scheduling is configured for a DRB), it may be more efficient to schedule the MAC PDUs based on their affiliation with PDU sets.

In certain aspects, the transmitter node drops all transport blocks (TBs) in a hybrid automatic repeat request (HARQ) buffer including data associated with a same PDU set, when at least one TB exceeds a preconfigured scheduling deadline.

In certain aspects, the receiver node may determine a MAC PDU in the type-A PDU set at a MAC layer to be obsolete, when a MAC sub-PDU associated with the MAC PDU reaches a L2 deadline. In certain aspects, the receiver node may then skip any uplink grants for the obsolete MAC PDU. This may trigger discarding of other data packets in the type-A PDU set in a PDCP or an RLC layer buffer.

In certain aspects, the receiver node applies quality of service (QOS) profile identifier (QPI) based procedures per PDU set, when a DRB is configured with both a QPI and an PDU set. For example, when the DRB is configured with both the QPI and the PDU set, all QPI-specific improvement procedures proposed herein are applied per PDU set instead of per PDU.

In certain aspects, the receiver node may need an PDU set header indicating PDU set information associated with one or more PDU sets. In the transmitter node, a cross-layer indication can be used to pass the PDU set information within the transmitter node. In the receiver node, a first layer in which the PDU set header is used corresponds to a layer in which the PDU set information has to be added to a protocol header. In one example, the layer may be a PDCP layer (e.g., since no other layer at the receiver node uses the PDU set information).

In certain aspects, the receiver node extracts the PDU set information associated with the one or more PDU sets from a general packet radio service tunneling protocol user-plane (GTP-U) extension header associated with each of the plurality of data packets. For example, as illustrated in FIG. 12, when an PDU set-affiliated data packet arrives at the SDAP layer, the PDU set information is extracted from a GTP-U header of the PDU set-affiliated data packet. In some cases, whether the transmitter node may aggregate the data packets of the same PDU set arriving at a same time into a single PDCP PDU may depend on node implementation.

In certain aspects, the PDU set information associated with the one or more PDU sets is transmitted between different layers of a user-plane protocol stack using a cross-layer indication. For example, the cross-layer indication may be used to pass the PDU set information associated with a PDU to lower layers.

In certain aspects, the PDU set information associated with the one or more PDU sets is added to a header of a PDCP data packet at a PDCP entity. For example, at the PDCP layer, the PDU set information is added to a PDCP PDU header and the receiver node extracts the PDU set information from the PDCP PDU header at the PDCP layer. As illustrated in FIG. 13, the PDU set information indicates at least number of packet indicator (NPI) indicating a number of packets, content policy indicator (CPI) indicating whether a content policy is included or not, PDU set sequence number (SN), last packet indicator (LPI), PDU index, content-policy type indicator (CPT) indicating a type of the included content policy, and PDU set reception information. In this example, the NPI is equal to 1 if a number of PDUs field is included in the PDU set information. The CPI is equal to 1 if the PDU set reception information field is included. The PDU set SN indicates a SN of an PDU set. The LPI is equal to 1 if a PDU is a last one in the PDU set. The PDU index is an index of the PDU within the PDU set indicating a total number of PDUs in the PDU set. The CPT is equal to 1 if the PDU set reception information is based on a number of bytes. The CPT is equal to 0 if the PDU set reception information is based on a number of data packets. When the CPT is equal to 1, the PDU set reception information field is of 15-bit; and when the CPT is equal to 0, the PDU set reception information field is of 7-bit.

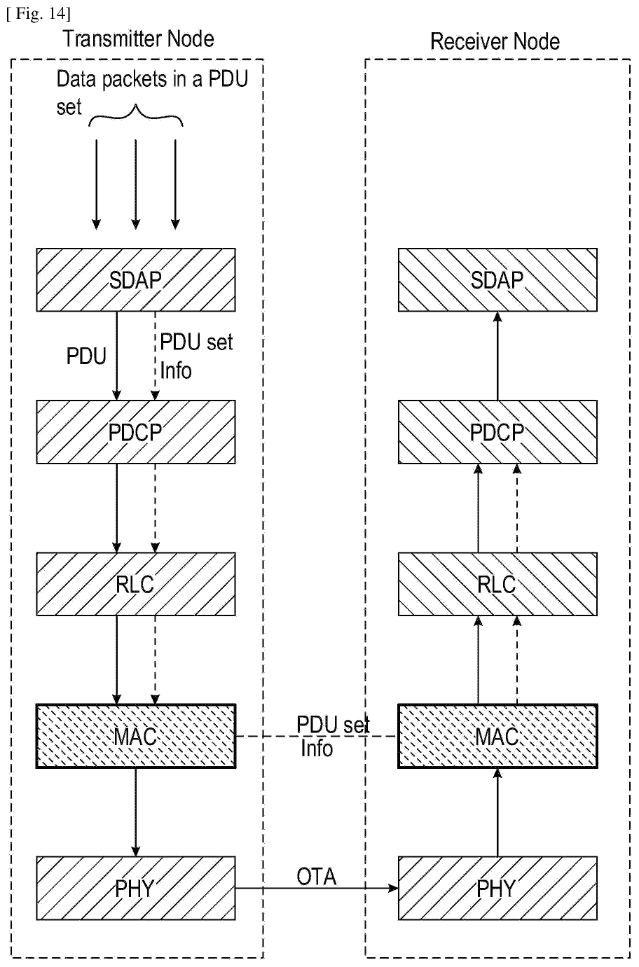

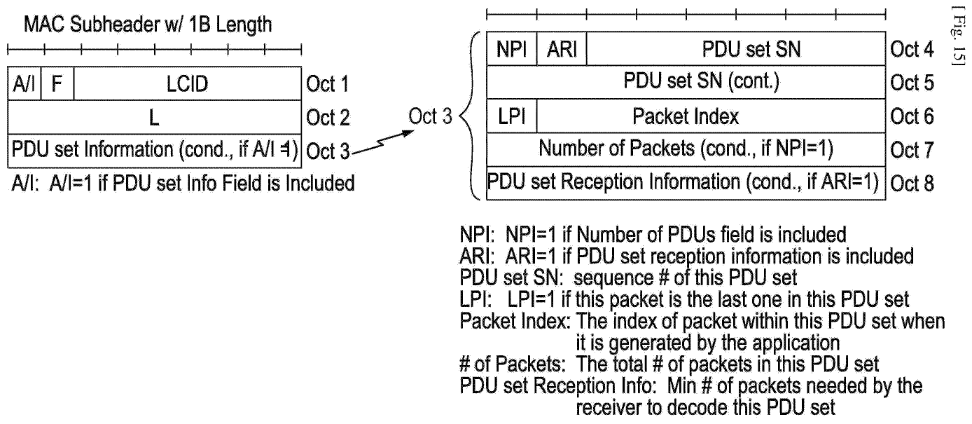

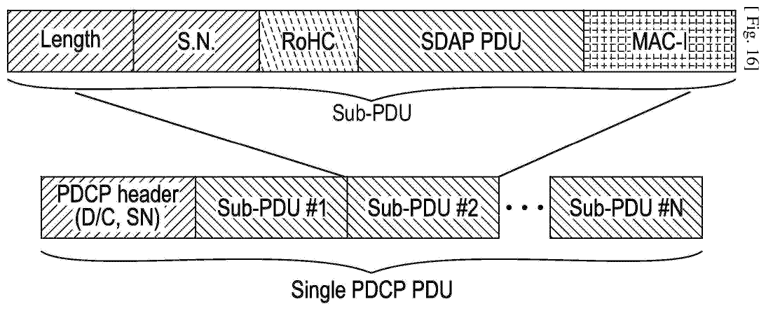

In certain aspects, a MAC layer may be a first layer where PDU set information is used at the receiver node, so the PDU set information is added to a header at the MAC layer. For example, as illustrated in FIG. 14, at the transmitter node, when an PDU set-affiliated data packet arrives at a SDAP layer, the PDU set information is extracted from a GTP-U header associated with the PDU set-affiliated data packet. The transmitter node may then use the cross-layer indication to pass the extracted PDU set information to lower layers. Furthermore, at the MAC layer, the PDU set information is then added to a MAC sub-PDU header. As further illustrated in FIG. 14, at the receiver node, the PDU set information is extracted from a header of the MAC sub-PDU at the MAC layer. The extracted PDU set information is then transmitted to one or more higher layers using the cross-layer indication.

As illustrated in FIG. 15, the PDU set information (e.g., in the MAC sub-PDU header) indicates at least NPI, PDU set reception information indicator (ARI), PDU set SN, LPI, a data packet index, a number of data packets, and PDU set reception information. In this example, the NPI is equal to 1 if a number of PDUs field is included in the PDU set information. The ARI is equal to 1 if PDU set reception information field is included. The PDU set SN indicates a SN of the PDU set. The LPI is equal to 1 if a data packet is a last one in the PDU set. The PDU index is an index of a data packet within the PDU set (e.g., when it is generated by XR application). The number of data packets correspond to a total number of data packets in the PDU set. The PDU set reception information indicates a minimum number of data packets needed by a receiver node to decode the PDU set.

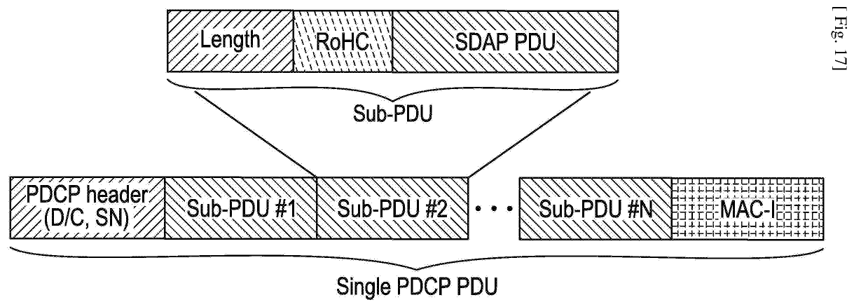

In certain aspects, PDCP procedures may be applied before aggregation of the plurality of data packets. For example, each SDAP PDU may be processed using the PDCP procedures for sequence numbering, header compression, integrity protection, and/or ciphering to form a sub-PDU (e.g., illustrated in FIG. 16). In some cases, SN and robust header compression (ROHC) fields in the sub-PDU may be optional (e.g., SN and ROFC may be indicated by some flags in a header). In some cases, after adding a length field, the SDAP PDU together with other headers produced using the PDCP procedures are assembled into the sub-PDU (which may be same as a conventional PDCP PDU). As further illustrated in FIG. 16, multiple sub-PDUs are assembled into a single PDCP PDU (e.g., including at least a PDCP header indicating SN, which is assigned per PDCP PDU).

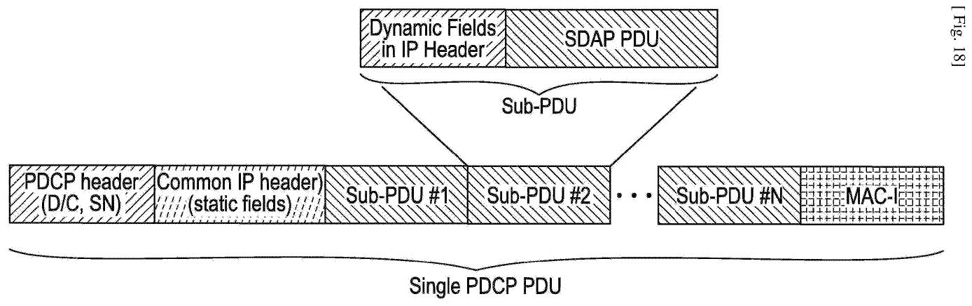

In certain aspects, PDCP procedures may be applied after aggregation of the plurality of data packets. For example, during application of the PDCP procedures, only ROHC field is applied to an individual SDAP PDU. As illustrated in FIG. 17, after adding a length field, the SDAP PDU together with the ROHC header is assembled into a sub-PDU. As further illustrated in FIG. 17, multiple sub-PDUs are assembled into a single PDCP PDU (e.g., including at least a PDCP header indicating SN which is assigned per PDCP PDU and an integrity field such as a MAC). In certain aspects, the receiver node processes the PDCP PDU using the PDCP procedures for header compression, integrity protection and/or ciphering.

In certain aspects, a static and dynamic part of a header associated with a data packet is separated. Each data packet forms a basis of a sub-PDU. The sub-PDU indicates a dynamic part of the header (e.g., a length, a framework offset, a time to live, etc.). In certain aspects, the receiver node maps all of the plurality of data packets to a single PDCP PDU. For example, as illustrated in FIG. 18, all sub-PDUs are grouped together and a common header (e.g., only the static part, such as source and destination address) is added to form the single PDCP PDU. In certain aspects, the receiver node may then process the PDCP PDU using the PDCP procedures (e.g., no ROHC is needed) for sequence numbering, integrity protection, and/or ciphering. This process may reduce overhead since all the sub-PDUs are grouped together and the common header.

In certain aspects, a network entity may radio resource control (RRC) configure whether a DRB should perform aggregation of the plurality of data packets or not.

In certain aspects, when the DRB is enabled to perform the aggregation of the plurality of data packets based on the RRC configuration, the network entity may RRC configure whether the aggregation has to be performed only within a same QoS flow, a configured subset of QoS flows, or all QoS flows in the same DRB. Each QoS flow can be identified based on its QFI, and the subset of QoS flows can be identified based on a QPI (e.g., a subset of QFIs for the subset of QoS flows are mapped to the QPI).

In certain aspects, when the DRB is enabled to perform the aggregation of the plurality of data packets based on the RRC configuration, the network entity may use MAC CE to dynamically activate and deactivate aggregation of the plurality of data packets.

In certain aspects, when the DRB is enabled to perform the aggregation of the plurality of data packets based on the RRC configuration, the network entity may configure whether or how much buffering is allowed before aggregation of the plurality of data packets. If the buffering is not configured, the aggregation applies only to the plurality of data packets that arrive at a same time. If the buffering is configured, the network entity may configure a delay threshold (e.g., after a SDAP PDU is received, how long may the receiver UE buffer the SDAP PDU before aggregating the SDAP PDU with other SDAP PDUs).

### Example Communications Device

FIG. 19 depicts aspects of an example communications device 1900. In some aspects, communications device 1900 is a receiver node, such as UE 104 described above with respect to FIGS. 1 and 3.

The communications device 1900 includes a processing system 1902 coupled to a transceiver 1908 (e.g., a transmitter and/or a receiver). The transceiver 1908 is configured to transmit and receive signals for the communications device 1900 via an antenna 1910, such as the various signals as described herein. The processing system 1902 may be configured to perform processing functions for the communications device 1900, including processing signals received and/or to be transmitted by the communications device 1900.

The processing system 1902 includes one or more processors 1920. In various aspects, the one or more processors 1920 may be representative of one or more of receive processor 358, transmit processor 364, TX MIMO processor 366, and/ or controller/processor 380, as described with respect to FIG. 3. The one or more processors 1920 are coupled to a computer-readable medium/memory 1930 via a bus 1906. In certain aspects, the computer-readable medium/memory 1930 is configured to store instructions (e.g., computer-executable code) that when executed by the one or more processors 1920, cause the one or more processors 1920 to perform the operations 800 described with respect to FIG. 8, or any aspect related to it. Note that reference to a processor performing a function of communications device 1900 may include one or more processors performing that function of communications device 1900.

In the depicted example, computer-readable medium/memory 1930 stores code (e.g., executable instructions) for receiving 1931 comprising code for receiving a plurality of data packets belonging to one or more protocol data unit (PDU) sets and an indication indicating a policy for a delivery procedure of one or more data packets in each PDU set to a higher layer, and code for delivering 1933 comprising code for delivering the one or more data packets within a same PDU set to the higher layer, in accordance with the policy. Processing of the code 1931-1933 may cause the communications device 1900 to perform the operations 800 described with respect to FIG. 8, or any aspect related to it.

The one or more processors 1920 include circuitry configured to implement (e.g., execute) the code stored in the computer-readable medium/memory 1930, including circuitry for receiving 1921 comprising circuitry for receiving a plurality of data packets belonging to one or more PDU sets and an indication indicating a policy for a delivery procedure of one or more data packets in each PDU set to a higher layer, and circuitry for delivering 1923 comprising circuitry for delivering the one or more data packets within a same PDU set to the higher layer, in accordance with the policy. Processing with circuitry 1921-1923 may cause the communications device 1900 to perform the operations 800 described with respect to FIG. 8, or any aspect related to it.

Various components of the communications device 1900 may provide means for performing the operations 800 described with respect to FIG. 8, or any aspect related to it. For example, means for transmitting, sending or outputting for transmission may include the transceivers 354 and/or antenna(s) 352 of the UE 104 illustrated in FIG. 3 and/or transceiver 1908 and antenna 1910 of the communications device 1900 in FIG. 19. Means for receiving or obtaining may include the transceivers 354 and/or antenna (s) 352 of the UE 104 illustrated in FIG. 3 and/or transceiver 1908 and antenna 1910 of the communications device 1900 in FIG. 19.

FIG. 20 depicts aspects of an example communications device 2000. In some aspects, communications device 2000 is a transmitter node, such as UE 104 described above with respect to FIGS. 1 and 3.

The communications device 2000 includes a processing system 2002 coupled to a transceiver 2008 (e.g., a transmitter and/or a receiver). The transceiver 2008 is configured to transmit and receive signals for the communications device 2000 via an antenna 2010, such as the various signals as described herein. The processing system 2002 may be configured to perform processing functions for the communications device 2000, including processing signals received and/or to be transmitted by the communications device 2000.

The processing system 2002 includes one or more processors 2020. In various aspects, the one or more processors 2020 may be representative of one or more of receive processor 358, transmit processor 364, TX MIMO processor 366, and/ or controller/processor 380, as described with respect to FIG. 3. The one or more processors 2020 are coupled to a computer-readable medium/memory 2030 via a bus 2006. In certain aspects, the computer-readable medium/memory 2030 is configured to store instructions (e.g., computer-executable code) that when executed by the one or more processors 2020, cause the one or more processors 2020 to perform the operations 900 described with respect to FIG. 9, or any aspect related to it. Note that reference to a processor performing a function of communications device 2000 may include one or more processors performing that function of communications device 2000.

In the depicted example, computer-readable medium/memory 2030 stores code (e.g., executable instructions) for receiving 2031 comprising code for receiving one or more data packets of a plurality of data packets within a same PDU set where the plurality of data packets belong to one or more PDU sets, and code for applying 2033 comprising code for applying one or more same processing procedures to the one or more data packets within the same PDU set. Processing of the code 2031-2033 may cause the communications device 2000 to perform the operations 900 described with respect to FIG. 9, or any aspect related to it.

The one or more processors 2020 include circuitry configured to implement (e.g., execute) the code stored in the computer-readable medium/memory 2030, including circuitry for receiving 2021 comprising circuitry for receiving one or more data packets of a plurality of data packets within a same PDU set where the plurality of data packets belong to one or more PDU sets, and circuitry for applying 2023 comprising circuitry for applying one or more same processing procedures to the one or more data packets within the same PDU set. Processing with circuitry 2021-2023 may cause the communications device 2000 to perform the operations 900 described with respect to FIG. 9, or any aspect related to it.

Various components of the communications device 2000 may provide means for performing the operations 900 described with respect to FIG. 9, or any aspect related to it. For example, means for transmitting, sending or outputting for transmission may include the transceivers 354 and/or antenna(s) 352 of the UE 104 illustrated in FIG. 3 and/or transceiver 2008 and antenna 2010 of the communications device 2000 in FIG. 20. Means for receiving or obtaining may include the transceivers 354 and/or antenna (s) 352 of the UE 104 illustrated in FIG. 3 and/or transceiver 2008 and antenna 2010 of the communications device 2000 in FIG. 20.

### Example Clauses

Implementation examples are described in the following numbered clauses:

Clause 1: A method for wireless communications by a receiver node, comprising: receiving a plurality of data packets belonging to one or more protocol data unit (PDU) sets and an indication indicating a policy for a delivery procedure of one or more data packets in each PDU set to a higher layer; and delivering the one or more data packets within a same PDU set to the higher layer, in accordance with the policy.

Clause 2: The method alone or in combination with the first clause: wherein the policy indicates a processing procedure of the one or more data packets in each PDU set; and processing the one or more data packets within the same PDU set in a same manner, in accordance with the policy.

Clause 3: The method alone or in combination with the first clause, further comprising mapping each data packet within the same PDU set to a single packet data convergence protocol (PDCP) protocol data unit (PDU).

Clause 4: The method alone or in combination with the first clause, wherein the one or more PDU sets comprise at least one of: a type-A PDU set or a type-B PDU set.

Clause 5: The method alone or in combination with the first clause, wherein: the policy indicates a type of each PDU set of the one or more PDU sets; and determining whether an PDU set of the one or more PDU sets is a type-A PDU set or a type-B PDU set based on the policy.

Clause 6: The method alone or in combination with the fourth clause, wherein when the PDU set of the one or more PDU sets is the type-A PDU set: determining whether at least one data packet of the one or more data packets within the type-A PDU set is lost or does not meet a deadline per a quality of service (QOS) requirement associated with the type-A PDU set during the delivery to the higher layer; and determining remaining data packets of the one or more data packets within the type-A PDU set to be of no use, when the at least one data packet is lost or does not meet the deadline per the QoS requirement.

Clause 7: The method alone or in combination with the fourth clause, further comprising determining a reception of the type-B PDU set to be successful, when at least a predetermined number of data packets or a number of bytes of the type-B PDU set are received.

Clause 8: The method alone or in combination with the fourth clause, further comprising determining to not deliver multiple data packets of a same type-A PDU set in a reordering buffer at a packet data convergence protocol (PDCP) entity to the higher layer until all of the data packets of the same type-A PDU set are received from a lower layer in the reordering buffer at the PDCP entity.

Clause 9: The method alone or in combination with the fourth clause, further comprising determining to discard all data packets in the same type-A PDU set or the type-B PDU set, when any data packet in the type-A PDU set or the type-B PDU set reaches a packet delay budget (PDB) limit while in a reordering buffer at a packet data convergence protocol (PDCP) entity.

Clause 10: The method alone or in combination with the fourth clause, wherein the delivering further comprises delivering the type-B PDU set to the higher layer, when at least a number of data packets or a number of bytes, according to the policy associated with the type-B PDU set, are received in a reordering buffer at a packet data convergence protocol (PDCP) entity.

Clause 11: The method alone or in combination with the first clause, wherein the delivering further comprises delivering the plurality of data packets based on the one or more PDU sets, when a data radio bearer (DRB) is configured for an out-of-order delivery of the plurality of data packets at a packet data convergence protocol (PDCP) entity.

Clause 12: The method alone or in combination with the first clause, further comprising dropping all transport blocks (TBs) in a hybrid automatic repeat request (HARQ) buffer comprising data associated with the same PDU set, when at least one TB exceeds a preconfigured scheduling deadline.

Clause 13: The method alone or in combination with the first clause, further comprising applying quality of service (QOS) profile identifier (QPI) based procedures per PDU set, when a data radio bearer (DRB) is configured with both a QPI and an PDU set.

Clause 14: The method alone or in combination with the first clause, further comprising extracting PDU set information associated with the one or more PDU sets from a general packet radio service tunneling protocol user-plane (GTP-U) extension header associated with each of the plurality of data packets.

Clause 15: The method alone or in combination with the fourteenth clause, wherein the PDU set information associated with the one or more PDU sets is transmitted between different layers of a user-plane protocol stack using a cross-layer indication.

Clause 16: The method alone or in combination with the fourteenth clause, wherein the PDU set information associated with the one or more PDU sets is added to a header of a packet data convergence protocol (PDCP) data packet at a PDCP entity.

Clause 17: The method alone or in combination with the first clause, wherein the receiving further comprises receiving the plurality of data packets at a service data adaption protocol (SDAP) layer.

Clause 18: The method alone or in combination with the first clause, wherein: a header of a packet data convergence protocol (PDCP) data packet indicates at least PDU set information, and the PDU set information indicates at least one of: NPI, CPI, PDU set sequence number (SN), LPI, PDU index, CPT, or PDU set reception information.

Clause 19: The method alone or in combination with the first clause, further comprising processing of each data packet within the same PDU set using one or more packet data convergence protocol (PDCP) procedures for at least one of: sequence numbering, header compression, integrity protection, or ciphering.

Clause 20: The method alone or in combination with the nineteenth clause, wherein a header of each processed data packet within the same PDU set indicates a length field.

Clause 21: The method alone or in combination with the twentieth clause, further comprising mapping all processed data packets within the same PDU set to a single PDCP protocol data unit (PDU).

Clause 22: The method alone or in combination with the first clause, wherein a header of each data packet within the same PDU set indicates a length field.

Clause 23: The method alone or in combination with the twenty-second clause, further comprising mapping all data packets within the same PDU set to a single packet data convergence protocol (PDCP) PDU set.

Clause 24: The method alone or in combination with the twenty-third clause, further comprising processing the PDCP PDU set using one or more PDCP procedures for at least a header compression.

Clause 25: The method alone or in combination with the first clause, further comprising mapping all of the plurality of data packets to a single packet data convergence protocol (PDCP) PDU set associated with a common header.

Clause 26: The method alone or in combination with the twenty-fifth clause, wherein: the common header corresponds to a static portion of a header associated with a data packet, and the static portion of the header comprises at least a source address and a destination address.

Clause 27: The method alone or in combination with the twenty-fifth clause, further comprising processing the PDCP PDU set using one or more PDCP procedures for at least one of: sequence numbering, integrity protection, or ciphering.

Clause 28: The method alone or in combination with the first clause, wherein the delivering further comprises delivering the plurality of data packets belonging to the one or more PDU sets, when a data radio bearer (DRB) is configured for an in-order delivery of the one or more PDU sets at a packet data convergence protocol (PDCP) entity.

Clause 29: The method alone or in combination with the twenty-eighth clause, wherein: the one or more PDU sets comprises a first PDU set and a second PDU set, and the second PDU set can not be delivered to the higher layer until all data packets of the first PDU set are received, based on the in-order delivery of the one or more PDU sets.

Clause 30: The method alone or in combination with the fourth clause, further comprising discarding a radio link control (RLC) data packet in the type-A PDU set at an RLC layer, when the RLC data packet reaches a layer 2 (L2) deadline.

Clause 31: The method alone or in combination with the thirtieth clause, wherein the discarding further triggers discarding of other data packets in the type-A PDU set in a packet data convergence protocol (PDCP) or a medium access control (MAC) layer buffer.

Clause 32: The method alone or in combination with the thirtieth clause, wherein the discarding further triggers transmission of a status of the RLC data packet to a transmitter node.

Clause 33: The method alone or in combination with the fourth clause, further comprising determining a medium access control (MAC) data packet in the type-A PDU set at a MAC layer to be obsolete, when a MAC sub-data packet associated with the MAC data packet reaches a layer 2 (L2) deadline.

Clause 34: The method alone or in combination with the thirty-third clause, further comprising skipping any uplink grants for the obsolete MAC data packet.

Clause 35: The method alone or in combination with the thirty-third clause, wherein the determining further comprises triggering discarding of other data packets in the type-A PDU set in a packet data convergence protocol (PDCP) or a radio link control (RLC) layer buffer.

Clause 36: The method alone or in combination with the first clause, further comprising extracting PDU set information from a header of a medium access control (MAC) sub-data packet at a MAC layer.

Clause 37: The method alone or in combination with the thirty-sixth clause, further comprising transmitting the extracted PDU set information to one or more higher layers using a cross-layer indication.

Clause 38: A method for wireless communications by a transmitter node, comprising: receiving one or more data packets of a plurality of data packets within a same protocol data unit (PDU) set, the plurality of data packets belong to one or more PDU sets; and applying one or more same processing procedures to the one or more data packets within the same PDU set.

Clause 39: The method alone or in combination with the thirty-eighth clause, further comprising determining whether the PDU set is a type-A PDU set or a type-B PDU set, based on an indication received from a higher layer.

Clause 40: The method alone or in combination with the thirty-eighth clause, wherein the one or more same processing procedures corresponds to procedures associated with at least a discard timer and a medium access control (MAC) layer enhancement.

Clause 41: The method alone or in combination with the thirty-eighth clause, wherein PDU set information associated with the one or more PDU sets is added to a header of each data packet.

Clause 42: The method alone or in combination with the thirty-eighth clause, wherein all data packets within the same PDU set are associated with a common discard timer.

Clause 43: The method alone or in combination with the thirty-eighth clause, further comprising routing all data packets within the same PDU set to a same uplink (UL) split bearer.

Clause 44: The method alone or in combination with the thirty-eighth clause, further comprising discarding all data packets within the same PDU set, when a radio link layer (RLC) receives an indication to discard the PDU set from a packet data convergence protocol (PDCP) entity.

Clause 45: The method alone or in combination with the thirty-eighth clause, further comprising dropping all transport blocks (TBs) in a hybrid automatic repeat request (HARQ) buffer comprising data associated with the same PDU set, when at least one TB exceeds a preconfigured scheduling deadline.

Clause 46: The method alone or in combination with the thirty-eighth clause, further comprising adding PDU set information to a header of a medium access control (MAC) sub-data unit at a MAC layer.

Clause 47: The method alone or in combination with the forty-sixth clause, wherein: the PDU set information indicates at least one of: NPI, ARI, PDU set sequence number (SN), LPI, a data packet index, a number of data packets, or PDU set reception information.

Clause 48: The method alone or in combination with the thirty-eighth clause, wherein the apply further comprises apply one or more radio link layer (RLC) procedures to the one or more data packets within the same PDU set at an RLC layer based on information associated with each individual data packet.

Clause 49: The method alone or in combination with the forty-eighth clause, further comprising discarding each individual data packet at the RLC layer, based on the information associated with each individual data packet, in accordance with the one or more RLC procedures.

Clause 50: An apparatus, comprising: a memory comprising executable instructions; and a processor configured to execute the executable instructions and cause the apparatus to perform a method in accordance with any one of Clauses 1-49.

Clause 51: An apparatus, comprising means for performing a method in accordance with any one of Clauses 1-49.

Clause 52: A non-transitory computer-readable medium comprising executable instructions that, when executed by a processor of an apparatus, cause the apparatus to perform a method in accordance with any one of Clauses 1-49.

Clause 53: A computer program product embodied on a computer-readable storage medium comprising code for performing a method in accordance with any one of Clauses 1-49.

### Additional Considerations

The preceding description is provided to enable any person skilled in the art to practice the various aspects described herein. The examples discussed herein are not limiting of the scope, applicability, or aspects set forth in the claims. Various modifications to these aspects will be readily apparent to those skilled in the art, and the general principles defined herein may be applied to other aspects. For example, changes may be made in the function and arrangement of elements discussed without departing from the scope of the disclosure. Various examples may omit, substitute, or add various procedures or components as appropriate. For instance, the methods described may be performed in an order different from that described, and various actions may be added, omitted, or combined. Also, features described with respect to some examples may be combined in some other examples. For example, an apparatus may be implemented or a method may be practiced using any number of the aspects set forth herein. In addition, the scope of the disclosure is intended to cover such an apparatus or method that is practiced using other structure, functionality, or structure and functionality in addition to, or other than, the various aspects of the disclosure set forth herein. It should be understood that any aspect of the disclosure disclosed herein may be embodied by one or more elements of a claim.

The various illustrative logical blocks, modules and circuits described in connection with the present disclosure may be implemented or performed with a general purpose processor, a digital signal processor (DSP), an ASIC, a field programmable gate array (FPGA) or other programmable logic device (PLD), discrete gate or transistor logic, discrete hardware components, or any combination thereof designed to perform the functions described herein. A general-purpose processor may be a microprocessor, but in the alternative, the processor may be any commercially available processor, controller, microcontroller, or state machine. A processor may also be implemented as a combination of computing devices, e.g., a combination of a DSP and a microprocessor, a plurality of microprocessors, one or more microprocessors in conjunction with a DSP core, a system on a chip (SoC), or any other such configuration.

As used herein, a phrase referring to “at least one of” a list of items refers to any combination of those items, including single members. As an example, “at least one of: a, b, or c” is intended to cover a, b, c, a-b, a-c, b-c, and a-b-c, as well as any combination with multiples of the same element (e.g., a-a, a-a-a, a-a-b, a-a-c, a-b-b, a-c-c, b-b, b-b-b, b-b-c, c-c, and c-c-c or any other ordering of a, b, and c).

As used herein, the term “determining” encompasses a wide variety of actions. For example, “determining” may include calculating, computing, processing, deriving, investigating, looking up (e.g., looking up in a table, a database or another data structure), ascertaining and the like. Also, “determining” may include receiving (e.g., receiving information), accessing (e.g., accessing data in a memory) and the like. Also, “determining” may include resolving, selecting, choosing, establishing and the like.

The methods disclosed herein comprise one or more actions for achieving the methods. The method actions may be interchanged with one another without departing from the scope of the claims. In other words, unless a specific order of actions is specified, the order and/or use of specific actions may be modified without departing from the scope of the claims. Further, the various operations of methods described above may be performed by any suitable means capable of performing the corresponding functions. The means may include various hardware and/or software component(s) and/or module(s), including, but not limited to a circuit, an application specific integrated circuit (ASIC), or processor.

The following claims are not intended to be limited to the aspects shown herein, but are to be accorded the full scope consistent with the language of the claims. Within a claim, reference to an element in the singular is not intended to mean “one and only one” unless specifically so stated, but rather “one or more.” Unless specifically stated otherwise, the term “some” refers to one or more. No claim element is to be construed under the provisions of 35 U.S.C. § 112 (f) unless the element is expressly recited using the phrase “means for”. All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims.

1. A receiver node configured for wireless communications, comprising:
a memory comprising computer-executable instructions; and
a processor configured to execute the computer-executable instructions and cause the receiver node to:
receive a plurality of data packets belonging to one or more protocol data unit (PDU) sets and an indication indicating a policy for a delivery procedure of one or more data packets in each PDU set to a higher layer; and
deliver the one or more data packets within a same PDU set to the higher layer, in accordance with the policy.

2. The receiver node of claim 1, wherein:
the policy indicates a processing procedure of the one or more data packets in each PDU set; and
the processor is configured to execute the computer-executable instructions and further cause the receiver node to process the one or more data packets within the same PDU set in a same manner, in accordance with the policy.

3. The receiver node of claim 1, wherein the processor is configured to execute the computer-executable instructions and further cause the receiver node to map each data packet within the same PDU set to a single packet data convergence protocol (PDCP) protocol data unit (PDU).

4. The receiver node of claim 1, wherein the one or more PDU sets comprise at least one of: a type-A PDU set or a type-B PDU set.

5. The receiver node of claim 1, wherein:
the policy indicates a type of each PDU set of the one or more PDU sets; and
the processor is configured to execute the computer-executable instructions and further cause the receiver node to determine whether an PDU set of the one or more PDU sets is a type-A PDU set or a type-B PDU set based on the policy.

6. The receiver node of claim 4, wherein when the PDU set of the one or more PDU sets is the type-A PDU set:
the processor is configured to execute the computer-executable instructions and further cause the receiver node to determine whether at least one data packet of the one or more data packets within the type-A PDU set is lost or does not meet a deadline per a quality of service (QoS) requirement associated with the type-A PDU set during the delivery to the higher layer; and
the processor is configured to execute the computer-executable instructions and further cause the receiver node to determine remaining data packets of the one or more data packets within the type-A PDU set to be of no use, when the at least one data packet is lost or does not meet the deadline per the QoS requirement.

7. The receiver node of claim 4, wherein the processor is configured to execute the computer-executable instructions and further cause the receiver node to determine a reception of the type-B PDU set to be successful, when at least a predetermined number of data packets or a number of bytes of the type-B PDU set are received.

8. The receiver node of claim 4, wherein the processor is configured to execute the computer-executable instructions and further cause the receiver node to determine to not deliver multiple data packets of a same type-A PDU set in a reordering buffer at a packet data convergence protocol (PDCP) entity to the higher layer until all of the data packets of the same type-A PDU set are received from a lower layer in the reordering buffer at the PDCP entity.

9. The receiver node of claim 4, wherein the processor is configured to execute the computer-executable instructions and further cause the receiver node to determine to discard all data packets in the same type-A PDU set or the type-B PDU set, when any data packet in the type-A PDU set or the type-B PDU set reaches a packet delay budget (PDB) limit while in a reordering buffer at a packet data convergence protocol (PDCP) entity.

10. The receiver node of claim 4, wherein the deliver further comprises deliver the type-B PDU set to the higher layer, when at least a number of data packets or a number of bytes, according to the policy associated with the type-B PDU set, are received in a reordering buffer at a packet data convergence protocol (PDCP) entity.

11. The receiver node of claim 1, wherein the deliver further comprises deliver the plurality of data packets based on the one or more PDU sets, when a data radio bearer (DRB) is configured for an out-of-order delivery of the plurality of data packets at a packet data convergence protocol (PDCP) entity.

12. The receiver node of claim 1, wherein the processor is configured to execute the computer-executable instructions and further cause the receiver node to drop all transport blocks (TBs) in a hybrid automatic repeat request (HARQ) buffer comprising data associated with the same PDU set, when at least one TB exceeds a preconfigured scheduling deadline.

13. The receiver node of claim 1, wherein the processor is configured to execute the computer-executable instructions and further cause the receiver node to apply quality of service (QOS) profile identifier (QPI) based procedures per PDU set, when a data radio bearer (DRB) is configured with both a QPI and an PDU set.

14. The receiver node of claim 1, wherein the processor is configured to execute the computer-executable instructions and further cause the receiver node to extract PDU set information associated with the one or more PDU sets from a general packet radio service tunneling protocol user-plane (GTP-U) extension header associated with each of the plurality of data packets.

15. The receiver node of claim 14, wherein the PDU set information associated with the one or more PDU sets is transmitted between different layers of a user-plane protocol stack using a cross-layer indication.

16. The receiver node of claim 14, wherein the PDU set information associated with the one or more PDU sets is added to a header of a packet data convergence protocol (PDCP) data packet at a PDCP entity.

17. The receiver node of claim 1, wherein the receive further comprises receive the plurality of data packets at a service data adaption protocol (SDAP) layer.

18. The receiver node of claim 1, wherein:
a header of a packet data convergence protocol (PDCP) data packet indicates at least PDU set information, and
the PDU set information indicates at least one of: NPI, CPI, PDU set sequence number (SN), LPI, PDU index, CPT, or PDU set reception information.

19. The receiver node of claim 1, wherein the processor is configured to execute the computer-executable instructions and further cause the receiver node to process of each data packet within the same PDU set using one or more packet data convergence protocol (PDCP) procedures for at least one of: sequence numbering, header compression, integrity protection, or ciphering.

20. The receiver node of claim 19, wherein a header of each processed data packet within the same PDU set indicates a length field.

21. The receiver node of claim 20, wherein the processor is configured to execute the computer-executable instructions and further cause the receiver node to map all processed data packets within the same PDU set to a single PDCP protocol data unit (PDU).

22. The receiver node of claim 1, wherein a header of each data packet within the same PDU set indicates a length field.

23. The receiver node of claim 22, wherein the processor is configured to execute the computer-executable instructions and further cause the receiver node to map all data packets within the same PDU set to a single packet data convergence protocol (PDCP) PDU set.

24. The receiver node of claim 23, wherein the processor is configured to execute the computer-executable instructions and further cause the receiver node to process the PDCP PDU set using one or more PDCP procedures for at least a header compression.

25. The receiver node of claim 1, wherein the processor is configured to execute the computer-executable instructions and further cause the receiver node to map all of the plurality of data packets to a single packet data convergence protocol (PDCP) PDU set associated with a common header.

26. The receiver node of claim 25, wherein:
the common header corresponds to a static portion of a header associated with a data packet, and
the static portion of the header comprises at least a source address and a destination address.

27. The receiver node of claim 25, wherein the processor is configured to execute the computer-executable instructions and further cause the receiver node to process the PDCP PDU set using one or more PDCP procedures for at least one of: sequence numbering, integrity protection, or ciphering.

28. The receiver node of claim 1, wherein the deliver further comprises deliver the plurality of data packets belonging to the one or more PDU sets, when a data radio bearer (DRB) is configured for an in-order delivery of the one or more PDU sets at a packet data convergence protocol (PDCP) entity.

29. The receiver node of claim 28, wherein:
the one or more PDU sets comprises a first PDU set and a second PDU set, and
the second PDU set can not be delivered to the higher layer until all data packets of the first PDU set are received, based on the in-order delivery of the one or more PDU sets.

30. The receiver node of claim 4, wherein the processor is configured to execute the computer-executable instructions and further cause the receiver node to discard a radio link control (RLC) data packet in the type-A PDU set at an RLC layer, when the RLC data packet reaches a layer 2 (L2) deadline.

31. The receiver node of claim 30, wherein the discard further triggers discard of other data packets in the type-A PDU set in a packet data convergence protocol (PDCP) or a medium access control (MAC) layer buffer.

32. The receiver node of claim 30, wherein the discard further triggers transmission of a status of the RLC data packet to a transmitter node.

33. The receiver node of claim 4, wherein the processor is configured to execute the computer-executable instructions and further cause the receiver node to determine a medium access control (MAC) data packet in the type-A PDU set at a MAC layer to be obsolete, when a MAC sub-data packet associated with the MAC data packet reaches a layer 2 (L2) deadline.

34. The receiver node of claim 33, wherein the processor is configured to execute the computer-executable instructions and further cause the receiver node to skip any uplink grants for the obsolete MAC data packet.

35. The receiver node of claim 33, wherein the determine further comprises triggering discard of other data packets in the type-A PDU set in a packet data convergence protocol (PDCP) or a radio link control (RLC) layer buffer.

36. The receiver node of claim 1, wherein the processor is configured to execute the computer-executable instructions and further cause the receiver node to extract PDU set information from a header of a medium access control (MAC) sub-data packet at a MAC layer.

37. The receiver node of claim 36, wherein the processor is configured to execute the computer-executable instructions and further cause the receiver node to transmit the extracted PDU set information to one or more higher layers using a cross-layer indication.

38. A transmitter node configured for wireless communications, comprising:
a memory comprising computer-executable instructions; and
a processor configured to execute the computer-executable instructions and cause the transmitter node to:
receive one or more data packets of a plurality of data packets within a same protocol data unit (PDU) set, the plurality of data packets belong to one or more PDU sets; and
apply one or more same processing procedures to the one or more data packets within the same PDU set.

39. The transmitter node of claim 38, wherein the processor is configured to execute the computer-executable instructions and further cause the transmitter node to determine whether the PDU set is a type-A PDU set or a type-B PDU set, based on an indication received from a higher layer.

40. The transmitter node of claim 38, wherein the one or more same processing procedures corresponds to procedures associated with at least a discard timer and a medium access control (MAC) layer enhancement.

41. The transmitter node of claim 38, wherein PDU set information associated with the one or more PDU sets is added to a header of each data packet.

42. The transmitter node of claim 38, wherein all data packets within the same PDU set are associated with a common discard timer.

43. The transmitter node of claim 38, wherein the processor is configured to execute the computer-executable instructions and further cause the transmitter node to route all data packets within the same PDU set to a same uplink (UL) split bearer.

44. The transmitter node of claim 38, wherein the processor is configured to execute the computer-executable instructions and further cause the transmitter node to discard all data packets within the same PDU set, when a radio link layer (RLC) receives an indication to discard the PDU set from a packet data convergence protocol (PDCP) entity.

45. The transmitter node of claim 38, wherein the processor is configured to execute the computer-executable instructions and further cause the transmitter node to drop all transport blocks (TBs) in a hybrid automatic repeat request (HARQ) buffer comprising data associated with the same PDU set, when at least one TB exceeds a preconfigured scheduling deadline.

46. The transmitter node of claim 38, wherein the processor is configured to execute the computer-executable instructions and further cause the transmitter node to add PDU set information to a header of a medium access control (MAC) sub-data unit at a MAC layer.

47. The transmitter node of claim 46, wherein: the PDU set information indicates at least one of: NPI, ARI, PDU set sequence number (SN), LPI, a data packet index, a number of data packets, or PDU set reception information.

48. The transmitter node of claim 38, wherein the apply further comprises apply one or more radio link layer (RLC) procedures to the one or more data packets within the same PDU set at an RLC layer based on information associated with each individual data packet.

49. The transmitter node of claim 48, wherein the processor is configured to execute the computer-executable instructions and further cause the transmitter node to discard each individual data packet at the RLC layer, based on the information associated with each individual data packet, in accordance with the one or more RLC procedures.

50. A method for wireless communications by a transmitter node, comprising:
receiving one or more data packets of a plurality of data packets within a same protocol data unit (PDU) set, the plurality of data packets belong to one or more PDU sets; and
applying one or more same processing procedures to the one or more data packets within the same PDU set.

51. The method of claim 50, wherein all data packets within the same PDU set are associated with a common discard timer.

52. The method of claim 50, wherein the applying further comprises applying one or more radio link layer (RLC) procedures to the one or more data packets within the same PDU set at an RLC layer based on information associated with each individual data packet.

53. The method of claim 52, further comprising discarding each individual data packet at the RLC layer, based on the information associated with each individual data packet, in accordance with the one or more RLC procedures.
